(19) United States
(12) Patent Application Publication
(10) Pub. No.: US 2023/0403598 A1
(43) Pub. Date: Dec. 14, 2023

(54) TRAFFIC IDENTIFIER-TO-LINK MAPPING METHODS AND MULTI-LINK DEVICES

(71) Applicant: GUANGDONG OPPO MOBILE TELECOMMUNICATIONS CORP., LTD., Dongguan (CN)

(72) Inventors: Liuming Lu, Dongguan (CN); Lei Huang, Singapore (SG); Chaoming Luo, Dongguan (CN)

(21) Appl. No.: 18/238,903

(22) Filed: Aug. 28, 2023

Related U.S. Application Data
(63) Continuation of application No. PCT/CN2021/089101, filed on Apr. 22, 2021.

(51) Int. Cl. H04W 28/02

(52) U.S. Cl. CPC H04W 28/0263; H04W 88/06

(57) ABSTRACT

Embodiments of the present disclosure provide Traffic Identifier (TID)-to-link mapping methods and Multi-Link Devices (MLDs), which may facilitate to improve efficiency of TID-to-link mapping negotiation. The method includes: transmitting, by a first MLD, a first TID-to-link mapping response frame to a second MLD. The first TID-to-link mapping response frame includes TID-to-link mapping response information, and the TID-to-link mapping response information includes a TID-to-link mapping parameter and/or type indication information indicating a response type of the first TID-to-link mapping response frame.

### CROSS-REFERENCE TO RELATED APPLICATIONS

This application is a continuation of International Application No. PCT/CN2021/089101 filed on Apr. 22, 2021, the entire disclosure of which is incorporated herein by reference.

### TECHNICAL FIELD

The embodiments of the present disclosure relate to the field of communication, and particularly, to Traffic Identifier (TID)-to-link mapping methods and Multi-Link Devices (MLDs).

### BACKGROUND

In related technologies, TID-to-link mapping setup between Multi-Link Devices (MLDs) needs to be completed by at least one handshake between the MLDs, and has lower negotiation efficiency. Therefore, how to improve the efficiency of the TID-to-Link mapping negotiation to reduce a TID-to-Link mapping delay is a problem that is desired to be solved.

### SUMMARY

Embodiments of the present disclosure provide TID-to-link mapping methods and MLDs, which may facilitate to improve the efficiency of the TID-to-link mapping negotiation.

In a first aspect, the present disclosure provides a Traffic Identifier (TID)-to-link mapping method. The TID-to-link mapping method includes: transmitting, by a first Multi-Link Device (MLD), a first TID-to-link mapping response frame to a second MLD.

The first TID-to-link mapping response frame includes TID-to-link mapping response information, and the TID-to-link mapping response information includes a TID-to-link mapping parameter and/or type indication information indicating a response type of the first TID-to-link mapping response frame.

In a second aspect, the present disclosure provides a Traffic Identifier (TID)-to-link mapping method. The TID-to-link mapping method includes: receiving, by a second Multi-Link Device (MLD), a first TID-to-link mapping response frame transmitted by a first MLD.

The first TID-to-link mapping response frame includes TID-to-link mapping response information, and the TID-to-link mapping response information includes a TID-to-link mapping parameter and/or type indication information indicating a response type of the first TID-to-link mapping response frame.

In a third aspect, the present disclosure provides a Multi-Link Device (MLD). The MLD is configured to perform the method according to the first aspect as described above.

Particularly, the MLD includes functional modules configured to perform the method according to the first aspect as described above.

In a fourth aspect, the present disclosure provides a Multi-Link Device (MLD). The MLD is configured to perform the method according to the second aspect as described above.

Particularly, the MLD includes functional modules configured to perform the method according to the second aspect as described above.

In a fifth aspect, the present disclosure provides a Multi-Link Device (MLD). The MLD includes a processor, and a memory having a computer program stored thereon. The processor is configured to invoke and execute the computer program stored on the memory, to perform the method according to the first aspect as described above.

In a sixth aspect, the present disclosure provides a Multi-Link Device (MLD). The MLD includes a processor, and a memory having a computer program stored thereon. The processor is configured to invoke and execute the computer program stored on the memory, to perform the method according to the second aspect as described above.

In a seventh aspect, an embodiment of the present disclosure provides a chip. The chip is configured to perform the method according to any one of the first aspect to the second aspect as described above.

Particularly, the chip includes: a processor. The processor is configured to invoke and execute a computer program from a memory, to cause a device equipped with the chip to perform the method according to any one of the first aspect to the second aspect as described above.

In an eighth aspect, the present disclosure provides a computer-readable storage medium. The computer-readable storage medium has a computer program stored thereon. The computer program causes a computer to perform the method according to any one of the first aspect to the second aspect as described above.

In a ninth aspect, the present disclosure provides a computer program product. The computer program product includes computer program instructions. The computer program instructions cause a computer to perform the method according to any one of the first aspect to the second aspect as described above.

In a tenth aspect, the present disclosure provides a computer program. The computer program, when run on a computer, causes the computer to perform the method according to any one of the first aspect to the second aspect as described above.

With the above technical solutions, by setting a plurality of response types of TID-to-link mapping response frames and/or a plurality of request types of TID-to-Link mapping request frames, a TID-to-Link mapping requester may perform a TID-to-Link mapping request with an appropriate type of TID-to-Link mapping request frame according to particular scenarios; and accordingly, a TID-to-Link mapping responder may perform a TID-to-Link mapping response with an appropriate type of TID-to-Link mapping response frame according to particular scenarios. This facilitates to satisfy requirements of different scenarios, and improve the negotiation efficiency for TID-to-Link mapping setup.

### BRIEF DESCRIPTION OF DRAWINGS

FIG. 1 is a schematic diagram of a communication system architecture in which embodiments of the present disclosure are applied.

FIG. 2 is a schematic diagram of a system architecture in which embodiments of the present disclosure are applied.

FIG. 3 is a schematic interactive diagram of a TID-to-link mapping method provided by an embodiment of the present disclosure.

FIG. 4 is the schematic structural diagram of a TID-to-link mapping element according to an embodiment of the present disclosure.

FIG. 5 is a schematic interactive diagram of a TID-to-link mapping method according to a particular example of the present disclosure.

FIG. 6 is a schematic interactive diagram of a TID-to-link mapping method according to another particular example of the present disclosure.

FIG. 7 is a schematic interactive diagram of a TID-to-link mapping method according to yet another particular example of the present disclosure.

FIG. 8 is a schematic block diagram of a Multi-Link Device (MLD) provided by an embodiment of the present disclosure.

FIG. 9 is a schematic block diagram of another Multi-Link Device (MLD) provided by an embodiment of the present disclosure.

FIG. 10 is a schematic block diagram of a communication device provided by an embodiment of the present disclosure.

FIG. 11 is a schematic block diagram of a chip provided by an embodiment of the present disclosure.

FIG. 12 is a schematic block diagram of a communication system provided by an embodiment of the present disclosure.

### DESCRIPTION OF EMBODIMENTS

The technical solutions of the embodiments of the present disclosure will be described below in conjunction with the drawings of the embodiments of the present disclosure. Obviously, the embodiments described are part, but not all, of the embodiments of the present disclosure. Based on the embodiments in the present disclosure, all other embodiments that can be obtained by the skilled in the art without any inventive labor also fall into the protection scope of the present disclosure.

The technical solutions of the embodiments of the present disclosure may be applied to various communication systems, such as a Wireless Local Area Networks (WLAN), a Wireless Fidelity (WiFi), or other communication systems.

For example, the communication system 100 in which the embodiments of the present disclosure are applied may be shown in FIG. 1. The communication system 100 may include an Access Point (AP) device 110, and a station (STA) device 120 accessing the network via the AP device 110.

In the embodiments of the present disclosure, the STA device may be deployed on land, including indoor or outdoor, handheld, wearable or in vehicle; or may be deployed on the water (such as a ship); or may deployed in the air (such as a plane, a balloon, a satellite).

In the embodiments of the present disclosure, the STA device may be a Mobile Phone, a Pad, a computer with a wireless transceiving function, a Virtual Reality (VR) device, an Augmented Reality (AR) device, a wireless device in industrial control, a wireless device in self driving, a wireless device in remote medical, a wireless device in smart grid, a wireless device in transportation safety, a wireless device in smart city, or a wireless device in smart home.

For illustration without any limitation, in the embodiments of the present disclosure, the STA device may also be a wearable device. The wearable device may also be called a wearable smart device, which is a general term for devices that are intelligently designed and developed to be wearable by applying wearable technology to daily wearing, such as glasses, gloves, watches, clothing and shoes. The wearable device is a portable device that is directly worn on the body or integrated into the user's clothes or accessories. The wearable device not only is a hardware device, but also provides powerful functions by software support, data interaction and cloud interaction. A broadly defined wearable smart device includes e.g., a smart watch or smart glasses, etc., which have richer functions, a larger size, and all or part of functions can be achieved independently of the smartphone, and e.g., a smart bracelet, a smart jewelry, etc. for sign monitoring, which only focuses on a certain type of application functions, and needs to cooperate with other devices such as the smartphone.

FIG. 1 exemplarily shows one AP and two STAs. Alternatively, the communication system 100 may include a plurality of APs, and other number of STAs, which is not limited by the embodiments of the present disclosure.

It should be understood that a device with communication functions in a network/system in the embodiments of the present disclosure may be called a communication device. Taking the communication system 100 as shown in FIG. 1 as an example, the communication device may include the access point 110 and the station 120 with communication functions. The access point 110 and the station 120 may be the particular devices as described above, which will not be described repetitively. The communication device may also include other devices in the communication system 100, such as a network controller, a gateway, and other network entities, which is not limited by the embodiments of the present disclosure.

It should be understood that the terms “system” and “network” are often interchangeable throughout the specification. The term “and/or” herein just defines some association between associated objects, which means that there may be three relationships. For example, A and/or B may include three cases where there is only A, there are both A and B, and there is only B. In addition, the character “/” herein generally indicates that the contextual objects are in an “or” relationship.

It should be understood that “indicating” mentioned in the embodiments of the present disclosure may be a direct indication, or an indirect indication, and may also mean that there is some association therebetween. For example, A indicating B may mean that A directly indicates B, for example, B may be obtained from A; or may mean that A indirectly indicates B, for example, A indicates C, and B may be obtained from C; or may mean that there is some association between A and B.

The terms used in the description of the present disclosure are only used for illustration, without any limitation, of the particular embodiments of the present disclosure. The terms “first”, “second”, “third” and “fourth” in the specification, claims, and accompanying drawings are used to distinguish different objects without any limitation on any particular order. In addition, the term “including”, “comprising”, “having”, and any variation thereof intend to cover non-exclusive containing.

In the embodiments of the present disclosure, the term “corresponding” may mean that there is a direct correspondence or an indirect correspondence between the both, or that there is an association between the two, or that they are in a relation of indicating and indicated, or configuring and configured.

In the embodiments of the present disclosure, the term “predefined” may be implemented by saving corresponding codes or tables in the device (e.g., including the station device and the access point device) in advance or in other ways applicable to indicate related information, which is not particularly limited in the embodiments of the present disclosure. For example, “predefined” may refer to being defined in protocols.

In the embodiment of the present disclosure, “protocol” may refer to a standard protocol in the communication field, for example, it may include a WiFi protocol, and related protocols applied to the future WiFi communication systems, which are not limited in the present disclosure.

In order to facilitate to understand the technical solutions of the embodiments of the present disclosure, the technical solutions of the present disclosure will be described below in detail by particular embodiments. The following related technologies, as alternatives, may be arbitrarily combined with the technical solutions of the embodiments of the present disclosure, all of which fall into the protection scope of the embodiments of the present disclosure. The embodiments of the present disclosure include at least part of the following content.

In order to increase the network capacity and reduce the network delay, a Multi-Link Aggregation (MLA) technology is introduced. In a system supporting the MLA technology, some traffic may be transmitted on at least two links. A device supporting MLA is a Multi-Link Device (MLD).

The MLD may include an AP MLD and a Non-AP MLD. In the embodiments of the present disclosure, the Non-AP MLD may be called a STA MLD.

In the embodiments of the present disclosure, the AP MLD may include a plurality of APs, and the Non-AP MLD may include a plurality of STAs. A plurality of links may be formed between the APs in the AP MLD and the STAs in the Non-AP MLD. Data communication may be performed between the APs in the AP MLD and the corresponding STAs in the Non-AP MLD via the respective links.

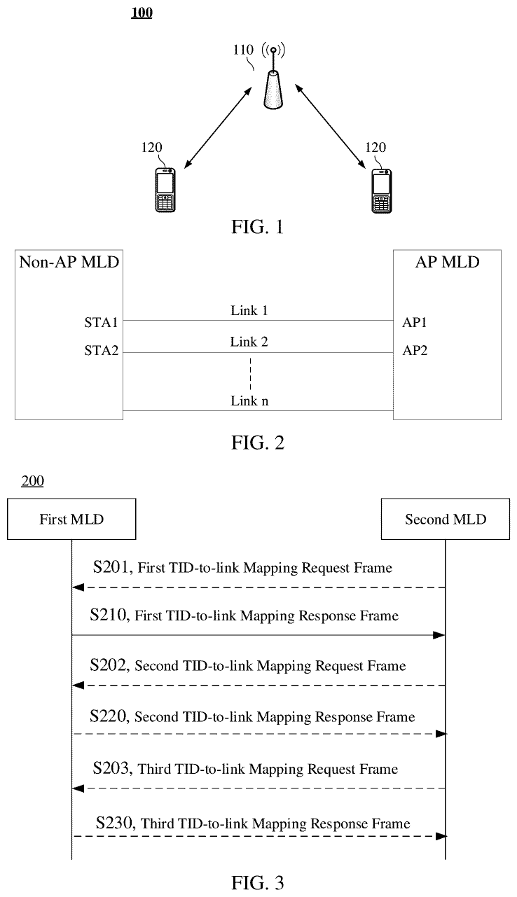

As shown in FIG. 2, the AP MLD may include AP1 and AP2, etc., and the Non-AP MLD may include STA1 and STA2, etc. Link 1 is formed between AP1 and STA1, Link 2 is formed between AP2 and STA2, and so on. Data communication may be performed between AP1 and STA1 via Link 1, and data communication may be performed between AP2 and STA2 via Link 2.

In related technologies, a TID-to-link mapping negotiation may be performed between the MLDs by transmission of a TID-to-link mapping request and a TID-to-link mapping response. Such a negotiation method has some problems as follows.
1. It is completed by at least one handshake between the MLDs, which cannot guarantee on-time transmission of low-latency traffic.
2. The efficiency of the negotiation is not high, and it is impossible to quickly understand the TID-to-link mapping requirements of the receiving MLD; the transmitting MLD and the receiving MLD simply transmit the TID-to-link mapping request and response; for example, when the receiving MLD denies the TID-to-link mapping request of the transmitting MLD, the transmitting MLD cannot know the TID-to-link mapping requirements of the receiving MLD, which cannot facilitate to quickly set up a TID-to-link between the receiving MLD and the transmitting MLD.

In view of this, the present disclosure provides a TID-to-link mapping method. By setting a plurality of request types or a plurality of response types, the requesting MLD may transmit an appropriate request type of TID-to-Link mapping request according to its own mapping requirements, and the responding MLD may use a corresponding type of TID-to-link mapping response according to the TID-to-Link mapping request of the requesting MLD and its own mapping requirements, which facilitates to satisfy the TID-to-link mapping requirements of different scenarios.

FIG. 3 is a schematic interactive diagram of a TID-to-link mapping method 200 provided by an embodiment of the present disclosure. As shown in FIG. 3, the method 200 may at least include:

S210, in which the first Multi-Link Device (MLD) transmits a first TID-to-link mapping response frame to a second MLD.

As an example, the first MLD is an AP MLD, and the second MLD is a Non-AP MLD.

As another example, the first MLD is a Non-AP MLD, and the second MLD is an AP MLD.

As yet another example, the first MLD is a first AP MLD, and the second MLD is a second AP MLD.

As yet another example, the first MLD is a first Non-AP MLD, and the second MLD is a second Non-AP MLD.

In some embodiments of the present disclosure, a plurality of links are established between the first MLD and the second MLD. The respective devices in the first MLD and the second MLD may perform data communication via the corresponding link.

For example, as shown in FIG. 2, the first MLD is an AP MLD, the second MLD is a Non-AP MLD. AP1 in the first MLD and STA1 in the second MLD may perform data communication via Link 1, and AP2 in the first MLD and STA2 in the second MLD may perform data communication via Link 2, and so on.

In some embodiments of the present disclosure, the first TID-to-link mapping response frame includes TID-to-link mapping response information. The TID-to-link mapping response information includes at least one of:
type indication information indicating that the first TID-to-link mapping response frame is a TID-to-link mapping response frame, and/or a response type of the first TID-to-link mapping response frame; or
a TID-to-link mapping parameter.

In some embodiments of the present disclosure, the method 200 further includes:

S201, in which the first MLD receives a first TID-to-link mapping request frame transmitted by the second MLD.

The first TID-to-link mapping response frame may be a response to the first TID-to-link mapping request frame.

In some embodiments of the present disclosure, the first TID-to-link mapping request frame includes TID-to-link mapping request information. The TID-to-link mapping request information includes at least one of:
type indication information indicating that the first TID-to-link mapping request frame is a TID-to-link mapping request frame, and/or a request type of the first TID-to-link mapping request frame; or
a TID-to-link mapping parameter.

In an embodiment of the present disclosure, the first MLD may be called a responding MLD, and the second MLD may be called a requesting MLD. That is, the first MLD may be a responder of TID-to-link mapping, and the second MLD may be a requester of TID-to-link mapping.

In some embodiments, the TID-to-link mapping may be set up by exchanging the TID-to-link mapping request frame and the TID-to-link mapping response frame between the MLDs for negotiation of the TID-to-link mapping.

Due to differences in link performance and traffic requirements, the TID-to-link mapping cannot be completed quickly. Therefore, how to implement a fast TID-to-link mapping to meet the traffic requirements is a problem desired to be solved.

In some embodiments of the present disclosure, a plurality of response types of TID-to-link mapping response frames and/or a plurality of request types of TID-to-link mapping request frames, so that the requester of the responder of the TID-to-link mapping may perform a TID-to-Link mapping request or response with an appropriate type of frame according to particular scenarios, which facilitates to improve the negotiation efficiency for TID-to-Link mapping setup.

In some embodiments of the present disclosure, the request type corresponding to the first TID-to-Link mapping request frame is one of:
a first request type, the first request type of TID-to-link mapping request frame including no TID-to-link mapping parameter;
a second request type, the second request type of TID-to-link mapping request frame including a TID-to-link mapping parameter required by the second MLD (or called a required TID-to-link mapping parameter); or
a third request type, the third request type of TID-to-link mapping request frame including a TID-to-link mapping parameter suggested by the second MLD (or called a suggested TID-to-link mapping parameter).

In some embodiments, if the requesting MLD transmits a TID-to-link mapping request frame that carries no TID-to-link mapping parameter (that is, the first request type of TID-to-link mapping request frame) to set up a TID-to-link link mapping, the responding MLD may determine whether to set up the TID-to-link mapping that the requesting MLD requests to set up, and the related TID-to-link mapping parameter. For example, the responding MLD may determine whether to set up the TID-to-link mapping according to the current TID-to-link mapping requirement, or the TID-to-link mapping parameter for setup of the TID-to-link mapping. For example, the responding MLD may set up a TID-to-link mapping based on the TID-to-link mapping parameter required by the responding MLD.

In some embodiments, if the requesting MLD transmits a TID-to-link mapping request frame carrying a required TID-to-link mapping parameter for requesting setup of a TID-to-link mapping, the responding MLD, after receiving the TID-to-link mapping request frame, may determine whether to set up the TID-to-link mapping that the requesting MLD requests to set up according to the required TID-to-link mapping parameter and/or the current TID-to-link mapping requirement. For example, if the responding MLD determines that the required TID-to-link mapping parameter cannot be satisfied, the responding MLD may deny setting up the TID-to-link mapping; or if the responding MLD expects to set up a TID-to-link mapping based on other TID-to-link mapping parameter(s), the responding MLD may reply the requesting MLD with other TID-to-link mapping parameter(s). In this case, the requesting MLD may deny accepting the TID-to-link mapping negotiation.

In some embodiments, if the requesting MLD transmits a TID-to-link mapping request frame carrying a suggested TID-to-link mapping parameter for requesting setup of a TID-to-link mapping, the responding MLD, after receiving the TID-to-link mapping request frame, may determine whether to set up the TID-to-link mapping that the requesting MLD requests to set up according to the suggested TID-to-link mapping parameter and/or the current TID-to-link mapping requirement. For example, if the responding MLD determines that the suggested TID-to-link mapping parameter cannot be satisfied, the responding MLD may deny setting up the TID-to-link mapping; or if the responding MLD expects to set up a TID-to-link mapping based on other TID-to-link mapping parameter(s), the responding MLD may reply the requesting MLD with other TID-to-link mapping parameter(s). In this case, the requesting MLD may accept the other TID-to-link mapping parameter(s) determined by the TID-to-link mapping negotiation.

In the embodiments of the present disclosure, for convenience of distinction and description, the first request type may also be called a Non-indicative TID-to-link mapping request frame, the second request type may also be called a Required TID-to-link mapping request frame, and the third request type may also be called a Suggested TID-to-link mapping request frame.

In some embodiments of the present disclosure, the response type of the TID-to-link mapping response frame may include Type 1 response type and/or Type 2 response type. The Type 1 response type of TID-to-link mapping response frame is a TID-to-link mapping response frame based on a TID-to-link mapping request frame, and the Type 2 response type of TID-to-link mapping response frame is a TID-to-link mapping response frame not based on a TID-to-link mapping request frame. That is, for the Type 1 response type, the transmitting party of the response frame transmits the TID-to-link mapping response frame in case of the TID-to-link mapping request frame being received. For the Type 2 response type, the transmitting party of the response frame transmits the TID-to-link mapping response frame without receiving the TID-to-link mapping request frame.

In some embodiments of the present disclosure, the Type 1 response type includes at least one of:
a first response type, the first response type of TID-to-link mapping response frame indicating that the first MLD accepts a TID-to-link mapping requested by the first TID-to-link mapping request frame;
a second response type, the second response type of TID-to-link mapping response frame indicating that the first MLD denies setting up the TID-to-link mapping requested by the first TID-to-link mapping request frame;
a third response type, the third response type of TID-to-link mapping response frame indicating that the first MLD does not set up the TID-to-link mapping requested by the first TID-to-link mapping request frame, and the third response type of TID-to-link mapping response frame including a TID-to-link mapping parameter required by the first MLD; or
a fourth response type, the fourth response type of TID-to-link mapping response frame indicating that the first MLD does not set up the TID-to-link mapping requested by the first TID-to-link mapping request frame, and the fourth response type of TID-to-link mapping response frame including a TID-to-link mapping parameter suggested by the first MLD.

In some embodiments, the first response type of TID-to-link mapping response frame may include no TID-to-link mapping parameter.

Alternatively, if the first response type of TID-to-link mapping response frame carries no TID-to-link mapping parameter, it may be considered that the first MLD, in case of receiving the TID-to-link mapping request frame transmitted by the second MLD, accepts the TID-to-link mapping parameter carried in the TID-to-link mapping request frame transmitted by the second MLD to set up the TID-to-link mapping between the first MLD and the second MLD.

In some embodiments, the first response type of TID-to-link mapping response frame may include a TID-to-link mapping parameter.

Alternatively, when the first response type of TID-to-link mapping response frame carries the TID-to-link mapping parameter, and the corresponding TID-to-link mapping request frame carries no TID-to-link mapping parameter, the TID-to-link mapping parameter carried in the first response type of TID-to-link mapping response frame may be a response to the TID-to-link mapping request frame that carries no TID-to-link mapping parameter, and a TID-to-link mapping between the requesting MLD and the responding MLD may be set up by the TID-to-link mapping parameter carried in the first response type of TID-to-link mapping response frame.

Alternatively, in some embodiments, the responding MLD may deny the TID-to-link mapping that the requesting MLD requests to set up, when the TID-to-link mapping parameter requested by the requesting MLD is not satisfied.

Alternatively, in some embodiments, the third response type of TID-to-link mapping response frame may indicate that the transmitting party of the TID-to-link mapping response frame does not set up a TID-to-link mapping, and at the same time, the TID-to-link mapping response frame also carries a TID-to-link mapping parameter, and the TID-to-link mapping parameter carried in the TID-to-link mapping response frame is different from the TID-to-link mapping parameter carried in the TID-to-link mapping request frame.

Alternatively, the TID-to-link mapping parameter carried in the third response type of TID-to-link mapping response frame may be a TID-to-link mapping parameter required by the first MLD. For example, the TID-to-link mapping parameter may be a TID-to-link mapping parameter that is determined by the first MLD according to the current TID-to-link mapping requirement and must be satisfied.

Alternatively, the third response type of TID-to-link mapping response frame may also indicate that only when the requesting MLD transmits a TID-to-link mapping request frame carrying a required TID-to-link mapping parameter indicated by the TID-to-link mapping response frame, it is possible for the responding MLD to accept setup of the TID-to-link mapping.

Alternatively, in some embodiments, the fourth response type of TID-to-link mapping response frame may indicate that the transmitting party of the TID-to-link mapping response frame does not set up a TID-to-link mapping, and at the same time, the TID-to-link mapping response frame also carries a TID-to-link mapping parameter, and the TID-to-link mapping parameter carried in the TID-to-link mapping response frame is different from the TID-to-link mapping parameter carried in the TID-to-link mapping request frame. Different from the TID-to-link mapping parameter carried in the third response type of TID-to-link mapping response frame, the fourth response type of TID-to-link mapping response frame carries the TID-to-link mapping parameter suggested or recommended by the first MLD, but not the TID-to-link mapping parameter that must be satisfied.

Alternatively, the fourth response type of TID-to-link mapping response frame may also indicate that when the requesting MLD transmits a TID-to-link mapping request frame carrying a suggested TID-to-link mapping parameter indicated by the TID-to-link mapping response frame, it is possible for the responding MLD to accept setup of the TID-to-link mapping.

It should be understood that the embodiments of the present disclosure do not limit the number of TID-to-link mapping parameters carried in the TID-to-link mapping response frame. For example, the TID-to-link mapping response frame may carry one TID-to-link mapping parameter or a plurality of TID-to-link mapping parameters, or may carry no TID-to-link mapping parameter.

In the embodiments of the present disclosure, for convenience of distinction and description, the first response type may also be called an Solicited Accept TID-to-link mapping response frame, that is, an Acceptance response frame based on the TID-to-link mapping request frame, the second response type may also be called a Denied TID-to-link mapping response frame, the third response type may also be called a Solicited Dictate Recommended TID-to-link mapping response frame, and the fourth response type can also be called a Solicited Alternative Recommended TID-to-link mapping response frame.

In some embodiments of the present disclosure, the Type 2 response type includes at least one of:
a fifth response type, the fifth response type of TID-to-link mapping response frame including a TID-to-link mapping parameter, and the receiving end of the fifth response type of TID-to-link mapping response frame setting up the TID-to-link mapping according to the TID-to-link mapping parameter;
a sixth response type, the sixth response type of TID-to-link mapping response frame including a TID-to-link mapping parameter required by the first MLD, and the receiving end of the sixth response type of TID-to-link mapping response frame transmitting, to the first MLD, a TID-to-link mapping request frame for setting up the TID-to-link mapping according to the TID-to-link mapping parameter required by the first MLD; or
a seventh response type, the seventh response type of TID-to-link mapping response frame including a TID-to-link mapping parameter suggested by the first MLD, and the receiving end of the seventh response type of TID-to-link mapping response frame transmitting, to the first MLD, a TID-to-link mapping request for setting up the TID-to-link mapping according to the TID-to-link mapping parameter suggested by the first MLD.

In some embodiments, the first MLD may, not based on the TID-to-link mapping request frame transmitted by the second MLD, transmit the fifth response type of TID-to-link mapping response frame to the second MLD, and set up a TID-to-link mapping between the first MLD and the second MLD. For example, the first MLD may initiate a TID-to-link mapping negotiation with the second MLD according to the current TID-to-link mapping requirement to set up a TID-to-link mapping between the first MLD and the second MLD.

In an implementation, after receiving the fifth response type of TID-to-link mapping response frame, the second MLD may set up a TID-to-link mapping with the first MLD based on the TID-to-link mapping parameter carried in the TID-to-link mapping response frame.

In another implementation, if the second MLD does not accept the TID-to-link mapping that the fifth response type of TID-to-link mapping response frame intends to set up, e.g., the TID-to-link mapping parameter carried in the fifth response type of TID-to-link mapping response frame cannot satisfy TID-to-link mapping requirement of the second MLD, the second MLD may transmit a TID-to-link mapping removal frame to the first MLD to remove the non-requested TID-to-link mapping.

In some embodiments, the first MLD may, not based on the TID-to-link mapping request frame transmitted by the second MLD, transmit the sixth response type of TID-to-link mapping response frame to the second MLD. The sixth response type of TID-to-link mapping response frame may include the TID-to-link mapping parameter required by the first MLD, that is, the required TID-to-link mapping parameter.

Alternatively, in some embodiments, the sixth response type of TID-to-link mapping response frame also indicates that only when the second MLD transmits a TID-to-link mapping request frame carrying a required TID-to-link mapping parameter indicated by the TID-to-link mapping response frame, it is possible for the first MLD to accept setup of the TID-to-link mapping.

In some embodiments, the first MLD may, not based on the TID-to-link mapping request frame transmitted by the second MLD, transmit the seventh response type of TID-to-link mapping response frame to the second MLD. The seventh response type of TID-to-link mapping response frame may include the TID-to-link mapping parameter suggested by the first MLD, i.e., the suggested TID-to-link mapping parameter.

Alternatively, the seventh response type of TID-to-link mapping response frame also indicates that only when the second MLD transmits a TID-to-link mapping request frame carrying a suggested TID-to-link mapping parameter indicated by the TID-to-link mapping response frame, it is possible for the first MLD to accept setup of the TID-to-link mapping.

In the embodiments of the present disclosure, for convenience of distinction and description, the fifth response type may also be called an Unsolicited Accept TID-to-link mapping response frame, the sixth response type may also be called a Unsolicited Dictate Recommended TID-to-link mapping response frame, and the seventh response type may also be called an Unsolicited Alternative Recommended TID-to-link mapping response frame.

In some embodiments of the present disclosure, the formats of the sixth response type and seventh response type may be implemented in the same manner as the aforementioned third response type and fourth response type, and the third response type and the sixth response type are collectively called Dictate Recommended TID-to-link mapping response frames, and the fourth response type and the seventh response type are collectively called Alternative Recommended TID-to-link mapping response frames.

The way of carrying information in the TID-to-link mapping request frame and the TID-to-link mapping response frame will be described below in combination with particular embodiments.

In some embodiments of the present disclosure, the first TID-to-link Mapping response frame includes a TID-to-link mapping element for carrying the TID-to-link mapping response information. That is, the TID-to-link mapping response information may be carried by the TID-to-link Mapping element.

Alternatively, the TID-to-link Mapping element may be carried by a management frame or an action frame. That is, the TID-to-link Mapping element may be included in the management frame or the action frame to carry the TID-to-link mapping response information.

Alternatively, the first TID-to-link mapping response frame may be a management frame or an action frame.

As an example, the first TID-to-link mapping response frame is one of:

a beacon frame, a probe response frame, an association response frame, or a reassociation response frame.

In some embodiments, the first TID-to-link mapping request frame includes a TID-to-link Mapping element for carrying the TID-to-link mapping request information. That is, the TID-to-link mapping request information may be carried by the TID-to-link Mapping element.

Alternatively, the TID-to-link Mapping element may be carried by a management frame or an action frame. That is, the TID-to-link Mapping element may be included in the management frame or the action frame to carry the TID-to-link mapping response information.

Alternatively, the first TID-to-link mapping request frame may be a management frame or an action frame.

As an example, the first TID-to-link mapping request frame is one of:

a beacon frame, an association request frame, or a reassociation request frame.

It should be understood that in the embodiments of the present disclosure, the TID-to-link mapping request frame and the TID-to-link mapping response frame may use the same frame format, or may also use different frame formats, which is not limited in the present disclosure.

Hereinafter, the TID-to-link mapping request frame and the TID-to-link mapping response frame using the same frame format is taken as an example to illustrate the details of the way of carrying the information in the TID-to-link mapping request frame and the TID-to-link mapping response frame, but the present disclosure is not limited thereto.

In some embodiments of the present disclosure, the TID-to-link mapping response information or the TID-to-link mapping request information may be carried by the TID-to-link Mapping element.

In some embodiments, the type indication information in the TID-to-link mapping request information may be indicated in one field, or may be indicated by means of multiple fields. Similarly, the type indication information in the TID-to-link mapping response information may be indicated in one field, or may be indicated by means of multiple fields, which is not limited in the present disclosure.

Alternatively, in some embodiments, the type indication information in the TID-to-link mapping request information may include frame type indication information indicating that the first TID-to-link mapping request frame is a TID-to-link mapping request frame and request type indication information indicating the request type of the first TID-to-link mapping request frame.

Alternatively, in some embodiments, the type indication information in the TID-to-link mapping response information may include frame type indication information indicating that the first TID-to-link mapping response frame is a TID-to-link mapping response frame and response type indication information indicating the response type of the first TID-to-link mapping response frame.

Alternatively, in some embodiments, the type indication information in the TID-to-link mapping response information and the type indication information in the TID-to-link mapping request information may be carried in the same field. For example, specific frame types or request/response types may be indicated by different values in the same field, or may be carried by different fields, which is not limited in the present disclosure. Hereinafter, the type indication information in the TID-to-link mapping response information and the type indication information in the TID-to-link mapping request information being carried in the same field is taken as an example for illustration, but the present disclosure is not limited thereto.

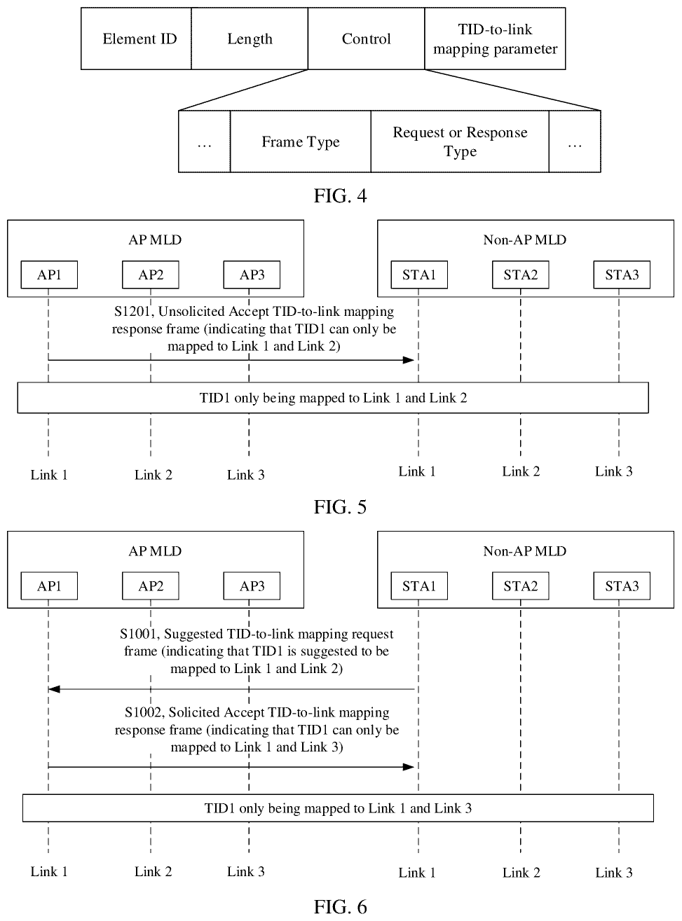

As shown in FIG. 4, the TID-to-link Mapping element includes a control field, and the control field includes a frame type field and a request/response type field. The frame type field indicates a specific frame type, such as a TID-to-link mapping request frame or a TID-to-link mapping response frame. A specific request type or response type is indicated by the request/or response type field.

That is, the frame type subfield may be a TID-to-link mapping frame type field, which indicates that the TID-to-link mapping frame is a TID-to-link mapping request frame or a TID-to-link mapping response frame. The request/response type field may be a subtype under the TID-to-link mapping frame type. For example, if the frame type field indicates that the TID-to-link mapping frame type is a TID-to-link mapping response frame, the request/response type field indicates a response type of the TID-to-link mapping response frame. For another example, if the frame type field indicates that the TID-to-link mapping frame type is a TID-to-link mapping request frame, the request/response type field indicates a request type of the TID-to-link mapping request frame.

Table 1 is an example of representing a request/response frame type and a request/response type by a TID-to-link Mapping element.

TABLE 1

| TID-to-link | Request or | |
|---|---|---|
| Mapping Frame | Response | TID-to-link Mapping Request/ |
| Type Field | Type Field | Response Frame Type |
| 0 | 000 | Non-Indicative TID-To-Link |
| | | Mapping Request Frame |
| 0 | 001 | Suggested TID-To-Link Mapping |
| | | Request Frame |
| 0 | 010 | Required TID-To-Link Mapping |
| | | Request Frame |
| 1 | 000 | Solicited Accept TID-To-Link |
| | | Mapping Response Frame |
| 1 | 001 | Unsolicited Accept TID-To-Link |
| | | Mapping Response Frame |
| 1 | 010 | Dictate Recommended TID-To-Link |
| | | Mapping Response Frame |
| 1 | 011 | Alternative Recommended TID-To-Link |
| | | Mapping Response Frame |
| 1 | 100 | Denied TID-To-Link Mapping |
| | | Response Frame |

It should be understood that the number of bits occupied by the TID-to-link mapping frame type field may be determined based on the number of TID-to-link mapping frame types that it needs to indicate. For example, if the TID-to-link mapping request frame and the TID-to-link mapping response frame need to be indicated, the TID-to-link mapping frame type field may occupy 1 bit, and the particular frame types may be indicated by different values of this 1 bit. Alternatively, if more types of TID-to-link mapping frames need to be indicated, such as the TID-to-link mapping request frame, the TID-to-link mapping response frame, and the TID-to-link mapping removal frame, the TID-to-link mapping frame type field may occupy 2 bits. Similarly, the number of bites occupied by the request/response type field may be determined based on the number of response types and the number of request types that need to be indicated. The present disclosure is not limited thereto.

It should be noted that the correspondence between the value in the mapping frame type field and the corresponding mapping frame type and the correspondence between the request/response type field and the corresponding request/response type are only examples. In other embodiments, other correspondences may be possible. The present disclosure is not limited to these examples.

In some embodiments of the present disclosure, the TID-to-link mapping response frame is an action frame, and the response type of the TID-to-link mapping response frame may be indicated in an Extremely High Throughput (EHT) Action field of the action frame. For example, different values in the EHT Action Field represent different response types.

In some embodiments of the present disclosure, the TID-to-link mapping request frame is an action frame, and the request type of the TID-to-link mapping request frame may also be indicated in the EHT Action field of the action frame. For example, different values in the EHT Action Field represent different request types.

Table 2 is an example of representing the aforementioned request types and response types by different values in the EHT Action Field.

TABLE 2

| Value | Description |
|---|---|
| 0 | Non-Indicative TID-To-Link Mapping Request Frame |
| 1 | Suggested TID-To-Link Mapping Request Frame |
| 2 | Required TID-To-Link Mapping Request Frame |
| 3 | Solicited Accept TID-To-Link Mapping Response Frame |
| 4 | Unsolicited Accept TID-To-Link Mapping Response Frame |
| 5 | Dictate Recommended TID-To-Link Mapping Response Frame |
| 6 | Alternative Recommended TID-To-Link Mapping Response |
| | Frame |
| 7 | Denied TID-To-Link Mapping Response Frame |

It should be noted that the correspondence between the value in the EHT Action field and the corresponding request/response type in Table 2 is only an example. In other embodiments, other correspondences may be possible. The present disclosure is not limited to these examples.

In some embodiments of the present disclosure, the TID-to-link mapping response frame is an action frame. The frame type of the TID-to-link mapping response frame may be indicated in the EHT Action field of the action frame. The response type of the TID-to-link mapping response frame is indicated in the Action field. Alternatively, the response type may be indicated by a newly added field, e.g., a newly added Subtype field in the Action field indicating the response type of the TID-to-link mapping response frame.

That is, the frame type of the TID-to-link mapping response frame may be carried in the EHT Action Field, and the response type of the TID-to-link mapping response frame may be carried in the Subtype field of the Action field.

In some embodiments of the present disclosure, the TID-to-link mapping request frame is an action frame. The frame type of the TID-to-link mapping request frame may be indicated in the EHT Action field of the action frame. The request type of the TID-to-link mapping request frame is indicated in the Action field. Alternatively, the request type may be indicated by a newly added field, e.g., a newly added Subtype field in the Action field indicating the request type of the TID-to-link mapping request frame.

That is, the frame type of the TID-to-link mapping request frame may be carried in the EHT Action Field, and the request type of the TID-to-link mapping request frame may be carried in the Subtype field of the Action field.

Table 3 is an example of indicating TID-to-link mapping frame types by different values in the EHT Action Field.

TABLE 3

| | Description (TID-To-Link |
|---|---|
| Value | Mapping Frame Type) |
| 0 | TID-To-Link Mapping Request Frame |
| 1 | TID-To-Link Mapping Response Frame |
| 2 | TID-To-Link Mapping Removal Frame |

It should be noted that the correspondence between the value in the EHT Action Field and the corresponding frame type in Table 3 is only an example. In other embodiments, other correspondences may be possible. The present disclosure is not limited to these examples.

In some embodiments, the Subtype field may be defined in the Action field of the TID-to-link mapping response frame or the TID-to-link mapping request frame, which is used to carry the corresponding request type or response type.

Table 4 is an example of definition of the action field of the TID-to-link mapping response frame or the TID-to-link mapping request frame.

TABLE 4

| Order | Information |
|---|---|
| 1 | Category |
| 2 | EHT Action |
| 3 | Dialog Token |
| 4 | Subtype |
| 5 | TID-To-Link Mapping |

Table 5 is an example of definition of the Subtype field of the TID-to-link mapping request frame.

TABLE 5

| | Description (TID-to-link Mapping |
|---|---|
| Value | Request Frame/Response Frame Type) |
| 0 | Non-Indicative TID-To-Link Mapping Request Frame |
| 1 | Suggested TID-To-Link Mapping Request Frame |
| 2 | Required TID-To-Link Mapping Request Frame |

It should be noted that the correspondence between the value in the Subtype field and the corresponding request type in Table 5 is only an example. In other embodiments, other correspondences may be possible. The present disclosure is not limited to these examples.

Table 6 is an example of definition of the Subtype field of the TID-to-link mapping response frame.

TABLE 6

| | Description (TID-to-link Mapping |
|---|---|
| Value | Request Frame/Response Frame Type) |
| 0 | Solicited Accept TID-to-Link Mapping Response |
| | Frame |
| 1 | Unsolicited Accept TID-To-Link Mapping Response |
| | Frame |
| 2 | Dictate TID-To-Link Mapping Response Frame |
| 3 | Alternative TID-To-Link Mapping Response Frame |
| 4 | Denied TID-To-Link Mapping Response Frame |

It should be noted that the correspondence between the value in the Subtype field and the corresponding response type in Table 6 is only an example. In other embodiments, other correspondences may be possible. The present disclosure is not limited to these examples.

In some other embodiments, the TID-to-link mapping request frame may indicate the request type by a Status Code field in the Action field. Similarly, the TID-to-link mapping response frame may indicate the response type by the Status Code field in the Action field.

Table 7 is an example of definition of the Status Code in the TID-to-link mapping request frame or the TID-to-link mapping response frame.

TABLE 7

| Order | Information |
|---|---|
| 1 | Category |
| 2 | EHT Action |
| 3 | Dialog Token |
| 4 | Status Code |
| 5 | TID-To-Link Mapping |

Table 8 is an example of definition of different response types by different values of the Status Code in the TID-to-link mapping response frame.

TABLE 8

| Status | | | |
|---|---|---|---|
| Code | Name | Response Type | Description |
| xx | ALTERNATIVE_TID_TO_LINK_MAPPING | Alternative | Indicating that a TID-to-link mapping is not |
| | | Recommended | set up, and the TID-to-link mapping |
| | | TID-To-Link | parameter carried in the TID-to-link |
| | | Mapping Response | mapping response is different from that in |
| | | Frame | the TID-to-link mapping request (if any), |
| | | | and at the same time, indicating one or more |
| | | | alternative TID-to-link mapping parameters. |
| | | | If the requesting MLD transmits a |
| | | | TID-to-link mapping request carrying any |
| | | | indicated TID-to-link mapping parameter, |
| | | | the responding MLD may use the |
| | | | TID-to-link mapping parameter to set up the |
| | | | TID-to-link mapping. |
| yy | DICTATE_TID_TO_LINK_MAPPING | Dictate | Indicating that a TID-to-link mapping is not |
| | | Recommended | set up, and the TID-to-link mapping |
| | | TID-To-Link | parameter carried in the TID-to-link |
| | | Mapping Response | mapping response is different from that in |
| | | Frame | the TID-to-link mapping request, and at the |
| | | | same time, indicating that only when the |
| | | | requesting MLD transmits a TID-to-link |
| | | | mapping request frame carrying the |
| | | | indicated TID-to-link mapping parameter, it |
| | | | is possible for the responding MLD to |
| | | | accept the indicated TID-to-link mapping. |
| zz | UNSOLICITED_ACCEPT_TID_TO_LINK_MAPPING | Unsolicited Accept | Setting up TID-to-link mapping between the |
| | | TID-To-Link | initiating MLD (i.e., the transmitting party |
| | | Mapping Response | of the TID-to-link mapping response) and |
| | | Frame | the receiving MLD (i.e., the receiving party |
| | | | of the TID-to-link mapping response) |
| | | | directly in a case where the TID-to-link |
| | | | mapping request frame is not received; |
| | | | transmitting a TID-to-link mapping removal |
| | | | frame to remove the non-requested |
| | | | TID-to-link mapping, if the receiving MLD |
| | | | does not accept the TID-to-link mapping |
| hh | SOLICITED_ACCEPT_TID_TO_LINK_MAPPING | Solicited Accept | Indicating the responding MLD to set up a |
| | | TID-To-Link | TID-to-link mapping between the requesting |
| | | Mapping Response | MLD and the responding MLD according to |
| | | Frame | the TID-to-link mapping parameter carried |
| | | | in the TID-to-link mapping request |
| | | | transmitted by the requesting MLD, when |
| | | | the TID-to-link mapping parameter is not |
| | | | carried; |
| | | | Indicating to set up a TID-to-link mapping |
| | | | between the requesting MLD and the |
| | | | responding MLD by the TID-to-link |
| | | | mapping parameter carried in the response |
| | | | frame, when the TID-to-link mapping |
| | | | parameter is carried. |
| ii | DENIED_TID_TO_LINK_MAPPING | Denied TID-To-Link | Denying the TID-to-link mapping request, |
| | | Mapping Response | which may be a deny response to the |
| | | Frame | Non-indicative TID-to-link mapping |
| | | | request, the suggested TID-to-link mapping |
| | | | request, and the required TID-to-link |
| | | | mapping request. |

It should be understood that the description of respective response types of TID-to-link mapping response frames in Table 8 is only an example, and specific implementations thereof may refer to the related description of the foregoing embodiments, and details thereof are not repeated here for brevity.

The types and the carried ways of the TID-to-link mapping request frame and the TID-to-link mapping response frame are described in detail above, and the TID-to-link mapping negotiation process will be described below in conjunction with specific embodiments.

In some scenarios, the first TID-to-link mapping response frame is a response to the first service TID-to-link mapping request frame. That is, the first TID-to-link mapping response frame may be the Type 1 response type.

In some embodiments of the present disclosure, the method 200 further includes:

determining, by the first MLD, the response type corresponding to the first TID-to-link mapping response frame based on the request type corresponding to the first TID-to-link mapping request frame and/or the TID-to-link mapping requirement of the first MLD.

Case 1: The first TID-to-link mapping request frame is the first request type of TID-to-link mapping request frame, that is, a Non-indicative TID-to-link mapping request frame.

In some implementations, when the requesting MLD transmits, to the responding MLD, a TID-to-link mapping request frame that carries no TID-to-link mapping parameter, that is, the first request type of TID-to-link mapping request frame, the responding MLD may reply the requesting MLD with a Solicited Accept TID-to-link mapping response, and the Solicited Accept TID-to-link mapping response includes a TID-to-link mapping parameter. The requesting MLD and the responding MLD set up a TID-to-link mapping based on the TID-to-link mapping parameter.

Alternatively, the TID-to-link mapping parameter included in the first request type of TID-to-link mapping request frame may be determined according to the TID-to-link mapping requirement of the responding MLD. For example, the TID-to-link mapping parameter included in the first request type of TID-to-link mapping request frame may be the TID-to-link mapping parameter required by the responding MLD or the TID-to-link mapping parameter suggested by the responding MLD.

In some other implementations, when the requesting MLD transmits, to the responding MLD, a TID-to-link mapping request frame that carries no TID-to-link mapping parameter, that is, the first request type of TID-to-link mapping request frame, the responding MLD may transmit a Denied TID-to-link mapping response frame to the requesting MLD. The Denied TID-to-link mapping response frame indicates that setup of the TID-to-link mapping between the requesting MLD and the responding MLD is denied.

Case 2: The first TID-to-link mapping request frame is the second request type of TID-to-link mapping request frame, that is, a Required TID-to-link mapping request frame.

In some implementations, when the requesting MLD transmits a TID-to-link mapping request frame carrying a required TID-to-link mapping parameter to the responding MLD, the responding MLD may reply the requesting MLD with a Solicited Accept TID-to-link mapping response frame, and the Solicited Accept TID-to-link mapping response frame includes no TID-to-link mapping parameter. The requesting MLD and the responding MLD set up a TID-to-link mapping based on the required TID-to-link mapping parameter.

In some other implementations, when the requesting MLD transmits a TID-to-link mapping request frame carrying a required TID-to-link mapping parameter to the responding MLD, the responding MLD may reply the requesting MLD with a Denied TID-to-link mapping request frame for denying setting up the TID-to-link mapping requested by the requesting MLD. The responding MLD may deny setting up the TID-to-link mapping requested by the requesting MLD in the case where the required TID-to-link mapping parameter cannot be satisfied.

In some yet other implementations, when the requesting MLD transmits a TID-to-link mapping request frame carrying a required TID-to-link mapping parameter to the responding MLD, the responding MLD may reply the requesting MLD with a Dictate Recommended TID-to-link mapping response frame for indicating that the TID-to-link mapping requested by the requesting MLD is not set up, and indicating a Required TID-to-link mapping of the responding MLD to the requesting MLD, so that the requesting MLD may re-initiate a TID-to-link mapping request based on the Required TID-to-link mapping parameter of the responding MLD, which facilitates to quickly set up a TID-to-link mapping between the requesting MLD and the responding MLD, and improves the negotiation efficiency. For example, the requesting MLD may re-initiate, to the responding MLD, a TID-to-link mapping request carrying the Required TID-to-link mapping parameter of the responding MLD, in the case where the Required TID-to-link mapping parameter of the responding MLD may satisfy the current TID-to-link mapping requirement of the requesting MLD.

In some yet other implementations, when the requesting MLD transmits a TID-to-link mapping request frame carrying a Required TID-to-link mapping parameter to the responding MLD, the responding MLD may reply the requesting MLD with an Alternative Recommended TID-to-link mapping response frame for indicating that the TID-to-link mapping requested by the requesting MLD is not set up, and indicating a Suggested TID-to-link mapping of the responding MLD to the requesting MLD, so that the requesting MLD may re-initiate a TID-to-link mapping request based on the Suggested TID-to-link mapping parameter of the responding MLD, which facilitates to quickly set up a TID-to-link mapping between the requesting MLD and the responding MLD, and improves the negotiation efficiency. For example, the requesting MLD may re-initiate, to the responding MLD, a TID-to-link mapping request carrying the Suggested TID-to-link mapping parameter of the responding MLD, in the case where the Suggested TID-to-link mapping parameter of the responding MLD may satisfy the current TID-to-link mapping requirement of the requesting MLD.

Alternatively, in the case of receiving the Required TID-to-link mapping request frame, the responding MLD determines with which type of response frame to reply, based on the Required TID-to-link mapping parameter in the Required TID-to-link mapping request frame and the current TID-to-link mapping requirement of the responding MLD. For example, in the case where the Required TID-to-link mapping parameter may be satisfied, the responding MLD transmits a Solicited Accept TID-to-link mapping response frame to the requesting MLD, or in the case where the Required TID-to-link mapping parameter cannot be satisfied, the responding MLD transmits, to the requesting MLD, a Denied TID-to-link mapping response frame, or an Alternative Recommended TID-to-link mapping response frame, or a Dictate Recommended TID-to-link mapping response frame, so as to quickly set up a TID-to-link mapping between the responding MLD and the requesting MLD.

Case 3: The first TID-to-link mapping request frame is the third request type of TID-to-link mapping request frame, that is, a Suggested TID-to-link mapping request frame.

In some implementations, when the requesting MLD transmits a TID-to-link mapping request frame carrying a Suggested TID-to-link mapping parameter to the responding MLD, the responding MLD may reply the requesting MLD with a Solicited Accept TID-to-link mapping parameter, and the Solicited Accept TID-to-link mapping parameter includes no TID-to-link mapping parameter. The requesting MLD and the responding MLD set up a TID-to-link mapping based on the suggested TID-to-link mapping parameter. For example, the responding MLD may transmit the Solicited Accept TID-to-link mapping response frame in the case where the Suggested TID-to-link mapping parameter may satisfy the current TID-to-link mapping requirement of the responding MLD.

In some other implementations, when the requesting MLD transmits a TID-to-link mapping request frame carrying a Suggested TID-to-link mapping parameter to the responding MLD, the responding MLD may reply the requesting MLD with a Solicited Accept TID-to-link mapping response frame, and the Solicited Accept TID-to-link mapping response frame includes a TID-to-link mapping parameter different from the TID-to-link mapping parameter included in the TID-to-link mapping request frame. Then, the requesting MLD and the responding MLD may set up a TID-to-link mapping based on the TID-to-link mapping parameter included in the TID-to-link mapping response frame. Alternatively, the requesting MLD may not accept the TID-to-link mapping parameter included in the TID-to-link mapping response frame. For example, the requesting MLD may transmit a TID-to-link mapping removal frame to the responding MLD to remove the TID-to-link mapping.

Alternatively, the TID-to-link mapping parameter included in the Solicited Accept TID-to-link mapping response frame may be the Required TID-to-link mapping parameter of the responding MLD or the Suggested TID-to-link mapping parameter of the responding MLD.

In some other implementations, when the requesting MLD transmits a TID-to-link mapping request frame carrying a Suggested TID-to-link mapping parameter to the responding MLD, the responding MLD may reply the requesting MLD with a Denied TID-to-link mapping response frame for denying setting up the TID-to-link mapping requested by the requesting MLD.

In yet some other implementations, when the requesting MLD transmits a TID-to-link mapping request frame carrying a Suggested TID-to-link mapping parameter to the responding MLD, the responding MLD may reply the requesting MLD with a Dictate Recommended TID-to-link mapping response frame indicating that the TID-to-link mapping requested by the requesting MLD is not set up, and indicating the Required TID-to-link mapping parameter of the responding MLD to the requesting MLD, so that the requesting MLD may re-initiate a TID-to-link mapping request based on the Required TID-to-link mapping parameter of the responding MLD, which facilitates to quickly set up a TID-to-link mapping between the requesting MLD and the responding MLD, and improves the negotiation efficiency. For example, the requesting MLD may re-initiate, to the responding MLD, a TID-to-link mapping request carrying the Required TID-to-link mapping parameter of the responding MLD, in the case where the Required TID-to-link mapping parameter of the responding MLD may satisfy the current mapping requirement of the responding MLD.

In yet some other implementations, when the requesting MLD transmits a TID-to-link mapping request frame carrying a Suggested TID-to-link mapping parameter to the responding MLD, the responding MLD may reply the requesting MLD with an Alternative Recommended TID-to-link mapping response frame for indicating that the TID-to-link mapping requested by the requesting MLD is not set up, and indicating the Suggested TID-to-link mapping parameter of the responding MLD to the requesting MLD, so that the requesting MLD may re-initiate a TID-to-link mapping request based on the Suggested TID-to-link mapping parameter of the responding MLD, which facilitates to quickly set up a TID-to-link mapping between the requesting MLD and the responding MLD, and improves the negotiation efficiency. For example, the requesting MLD may re-initiate, to the responding MLD, a TID-to-link mapping request carrying the Suggested TID-to-link mapping parameter of the responding MLD, in the case where the Suggested TID-to-link mapping parameter of the responding MLD may satisfy the current mapping requirement of the responding MLD.

Alternatively, in the case of receiving the Suggested TID-to-link mapping request frame, the responding MLD may determine with which type of response frame to reply, based on the Suggested TID-to-link mapping parameter in the Suggested TID-to-link mapping request frame and the current TID-to-link mapping requirement of the responding MLD. For example, in the case where the Suggested TID-to-link mapping parameter may be satisfied, the responding MLD transmits a Solicited Accept TID-to-link mapping response frame to the requesting MLD, or in the case where the Suggested TID-to-link mapping parameter cannot be satisfied, the responding MLD transmits, to the requesting MLD, a Denied TID-to-link mapping response frame, or an Alternative Recommended TID-to-link mapping response frame, or a Dictate Recommended TID-to-link mapping response frame, so as to quickly set up a TID-to-link mapping between the responding MLD and the requesting MLD.

Alternatively, in some embodiments of the present disclosure, as shown in FIG. 3, the method 200 further includes:

S202, in which the first MLD receives the second TID-to-link mapping request frame transmitted by the second MLD, the second TID-to-link mapping request frame including a TID-to-link mapping parameter required by the first MLD.

In some embodiments, if the second MLD receives the third response type or the sixth response type of first TID-to-link mapping response frame transmitted by the first MLD, the second MLD may re-initiate, to the first MLD, a TID-to-link mapping request for requesting to set up a TID-to-link mapping based on the Required TID-to-link mapping parameter of the first MLD, so as to speed up the TID-to-link mapping setup process and improve the negotiation efficiency.

Further, in some embodiments of the present disclosure, as shown in FIG. 3, the method 200 further includes:

S220, in which the first MLD transmits a second TID-to-link mapping response frame to the second MLD.

In some embodiments, the second TID-to-link mapping response frame indicates that the first MLD accepts the TID-to-link mapping that the second TID-to-link mapping request frame requests to set up.

For example, the second TID-to-link mapping response frame may be a Solicited Accept TID-to-link mapping response frame.

Alternatively, the TID-to-link mapping parameter is not included in the Solicited Accept TID-to-link mapping response frame.

Alternatively, in some embodiments of the present disclosure, as shown in FIG. 3, the method 200 further includes:

S203, in which the first MLD receives a third TID-to-link mapping request frame transmitted by the second MLD, the third TID-to-link mapping request frame including a TID-to-link mapping parameter suggested by the first MLD.

In some embodiments, if the second MLD receives the fourth response type or the seventh response type of first TID-to-link mapping response frame transmitted by the first MLD, the second MLD may re-initiate a TID-to-link mapping request to the first MLD, for requesting to set up a TID-to-link mapping based on the suggested TID-to-link mapping parameter of the first MLD, so as to speed up the TID-to-link setup process and improve the negotiation efficiency.

Alternatively in some embodiments of the present disclosure, as shown in FIG. 3, the method 200 further includes:

S230, in which the first MLD transmits a third TID-to-link mapping response frame to the second MLD.

In some embodiments, the third TID-to-link mapping response frame indicates that the first MLD accepts the TID-to-link mapping request of the third TID-to-link mapping request frame.

For example, the third TID-to-link mapping response frame may be a Solicited Accept TID-to-link mapping response frame.

Alternatively, the TID-to-link mapping parameter is not included in the Solicited Accept TID-to-link mapping response frame.

In summary, the TID-to-link mapping negotiation in the embodiments of the present disclosure may include Solicited TID-to-link mapping negotiation and/or Unsolicited TID-to-link mapping negotiation.

In the Solicited TID-to-link mapping negotiation, the requesting MLD needs to transmit a TID-to-link mapping request frame first, such as a Non-indicative TID-to-link mapping request frame, a Suggested TID-to-link mapping request frame, a Required TID-to-link mapping request frame, etc. The responding MLD may select a corresponding type of TID-to-link mapping response frame to reply with according to the request type of the TID-to-link mapping request frame and the requested TID-to-link mapping parameter, as well as the TID-to-link mapping requirement of the responding MLD. For example, a non-AP MLD, as a requesting MLD, transmits a TID-to-link mapping request frame on a link, and an AP MLD, as a responding MLD, replies with a TID-to-link mapping response frame on the same link. Table 9 is a schematic diagram of frame interactions of a Solicited TID-to-link mapping negotiation according to some specific examples of the present disclosure.

TABLE 9

| | | |
|---|---|---|
| TID-To-Link | TID-To-Link | TID-to-link mapping state after frame interaction |
| Mapping | Mapping | |
| Negotiation | Negotiation | |
| Initiation Frame | Response Frame | |
| (TID-To-Link | (TID-To-Link | |
| Mapping Request | Mapping Response | |
| Frame) | Frame) | |
| Non-Indicative | Solicited Accept | A TID-to-link mapping between the requesting MLD and |
| TID-To-Link | TID-To-Link | the responding MLD is set up according to the |
| Mapping Request | Mapping Response | TID-to-link mapping |
| Frame | Frame | parameter carried in the Solicited |
| | | Accept TID-to-link mapping response frame. |
| Suggested | Solicited Accept | When the Solicited Accept TID-to-link mapping response |
| TID-To-Link | TID-To-Link | carries no TID-to-link mapping parameter, a TID-to-link |
| Mapping Request | Mapping Response | mapping between the requesting MLD and the |
| Frame | | responding MLD is set up according to the TID-to-link |
| | | mapping parameter carried in the TID-to-link mapping |
| | | request transmitted by the requesting MLD; |
| | | When the Solicited Accept TID-to-link mapping response |
| | | carries a TID-to-link mapping parameter, a TID-to-link |
| | | mapping between the requesting MLD and the |
| | | responding MLD is set up according to the carried |
| | | TID-to-link mapping parameter. |
| Required | Solicited Accept | A TID-to-link mapping between the requesting MLD and |
| TID-To-Link | TID-To-Link | the responding MLD is set up according to the |
| Mapping Request | Mapping Response | TID-to-link mapping parameter carried in the TID-to-link |
| Frame | Frame | mapping request frame transmitted by the requesting |
| | | MLD. |
| Non-Indicative | Denied | The responding MLD denies setting up a TID-to-link |
| TID-To-Link | TID-To-Link | mapping with the requesting MLD, and no new |
| Mapping Request | Mapping Response | TID-to-link mapping is set up. |
| Frame, Suggested | Frame | |
| TID-To-Link | | |
| Mapping Request | | |
| Frame, Required | | |
| TID-To-Link | | |
| Mapping Request | | |
| Frame | | |
| Suggested | Dictate | No new TID-to-link mapping is set up, and the |
| TID-To-Link | Recommended | TID-to-link mapping parameter carried by the responding |
| Mapping Request | TID-To-Link | MLD in the TID-to-link mapping response is different |
| Frame, Required | Mapping Response | from that in the TID-to-link mapping request; and at the |
| TID-To-Link | Frame | same time, it is indicated that it is possible to accept the |
| Mapping Request | | indicated TID-to-link mapping only when the requesting |
| Frame | | MLD transmits a new TID-to-link mapping request |
| | | carrying the indicated TID-to-link mapping parameter. |
| Suggested | Alternative | No new TID-to-link mapping is set up, and the |
| TID-To-Link | Recommended | TID-to-link mapping parameter carried in the TID-to-link |
| Mapping Request | TID-To-Link | mapping response by the responding MLD is different |
| Frame, Required | Mapping Response | from that in the TID-to-link mapping request (if any); |
| TID-To-Link | Frame | and at the same time, one or more optional TID-to-link |
| Mapping Request | | mapping parameters are indicated; if the requesting MLD |
| Frame | | transmits a new TID-to-link mapping request carrying the |
| | | indicated TID-to-link mapping parameter, it is possible to |
| | | set up a TID-to-link mapping based on the TID-to-link |
| | | mapping parameter. |

In the Unsolicited TID-to-link mapping negotiation, the responding MLD may directly transmit the corresponding type of TID-to-link mapping response frame to initiate the TID-to-link mapping setup process according to the TID-to-link mapping requirements of the responding MLD. For example, the AP MLD, as the negotiation initiator, transmits a TID-to-link mapping response on a link, indicating the corresponding TID-to-link mapping negotiation operation. Table 10 is a schematic diagram of frame interactions of an Unsolicited TID-to-link mapping negotiation according to some specific examples of the present disclosure.

TABLE 10

| | | |
|---|---|---|
| TID-To-Link | TID-To-Link | TID-to-link mapping state after frame interaction |
| Mapping | Mapping | |
| Negotiation | Negotiation | |
| Initiation Frame | Response Frame | |
| Unsolicited Accept | No Frame | The receiving MLD sets up a TID-to-link mapping |
| TID-To-Link | Transmission | with the initiator MLD after receiving the |
| Mapping Response | | Unsolicited Accept TID-to-link mapping response |
| Frame | | frame |
| Dictate | No Frame | The receiving MLD does not set up a TID-to-link |
| Recommended | Transmission | mapping with the initiator MLD after receiving the |
| TID-To-Link | | Dictate Recommended TID-to-link mapping |
| Mapping Response | | response frame, and a TID-to-link mapping request |
| Frame | | can only be transmitted using the TID-to-link |
| | | mapping parameter in the Dictate Recommended |
| | | TID-to-link mapping response frame, in order to set |
| | | up a TID-to-link mapping. |
| Alternative | No Frame | The receiving MLD does not set up a TID-to-link |
| Recommended | Transmission | mapping with the initiator MLD after receiving the |
| TID-To-Link | | Alternative Recommended TID-to-link mapping |
| Mapping Response | | response frame, and a TID-to-link mapping request |
| Frame | | may be transmitted using the TID-to-link mapping |
| | | parameter in the Alternative Recommended |
| | | TID-to-link mapping response frame, in order to set |
| | | up a TID-to-link mapping. |

Hereinafter, a TID-to-link mapping method according to an embodiment of the present disclosure will be described in conjunction with Embodiment 1 to Embodiment 3.

In Embodiment 1 to Embodiment 3, the first MLD is an AP MLD, including AP1, AP2, and AP3, and the second MLD is a Non-AP MLD, including STA1, STA2, and STA3. Link1 is established between AP1 and STA1, Link 2 is established between AP2 and STA2, and Link 3 is established between AP3 and STA3.

### Embodiment 1: The AP MLD, as a TID-to-Link Mapping Negotiation Initiator, Directly Initiates a TID-to-Link Mapping Negotiation Process

As shown in FIG. 5, it may include the following steps:

S1201, in which the AP MLD transmits an Unsolicited Accept TID-to-link mapping response frame on Link 1, and the Unsolicited Accept TID-to-link mapping response frame includes a TID-to-link mapping parameter indicating that TID1 can only be mapped to Link 1 and Link 2.

The Non-AP MLD, as the receiving party of TID-to-link mapping negotiation, directly sets up a TID-to-link mapping after receiving the Unsolicited Accept TID-to-link mapping response frame. That is, TID1 can only be mapped to Link 1 and Link 2. For example, if TID1 is a TID of a delay-sensitive traffic, data units of the delay-sensitive traffic can only be transmitted on Link 1 and Link 2.

Alternatively, the Non-AP MLD may also transmit a TID-to-link mapping removal frame to remove the unsolicited TID-to-link mapping. For example, when the TID-to-link mapping parameter in the Unsolicited Accept TID-to-link mapping response frame cannot satisfy the current TID-to-link mapping requirement of the Non-AP MLD, the TID-to-link mapping removal frame is transmitted.

### Embodiment 2: The Non-AP MLD Acts as a TID-to-Link Mapping Negotiation Initiator

As shown in FIG. 6, it may include the following steps:

S1001, in which the Non-AP MLD transmits a Suggested TID-to-link mapping request frame, and the Suggested TID-to-link mapping request frame includes a Suggested TID-to-link mapping parameter indicating that TID1 is suggested to be mapped to Link1 and Link2.

S1002, in which the AP MLD receives the Suggested TID-to-link mapping request frame, and the AP MLD transmits a Solicited Accept TID-to-link response frame that carries a Required TID-to-link mapping parameter of the AP MLD for indicating that TID1 can only be mapped to Link 1 and Link 3.

Alternatively, the AP MLD may transmit a Solicited Accept TID-to-link mapping response frame carrying the Required TID-to-link mapping parameter, or transmit a Dictate Recommended TID-to-link mapping response frame, in the case where the Suggested TID-to-link mapping parameter carried by the Suggested TID-to-link mapping request frame cannot satisfy the current TID-to-link mapping cell of the AP MLD.

S1003, in which after receiving the Solicited Accept TID-to-link mapping response frame, the Non-AP MLD sets up a TID-to-link mapping based on the TID-to-link mapping parameter carried in the Solicited Accept TID-to-link mapping response frame, that is, TID1 can only be mapped to Link1 and Link3.

### Embodiment 3: The Non-AP MLD Acts as a TID-to-Link Mapping Negotiation Initiator

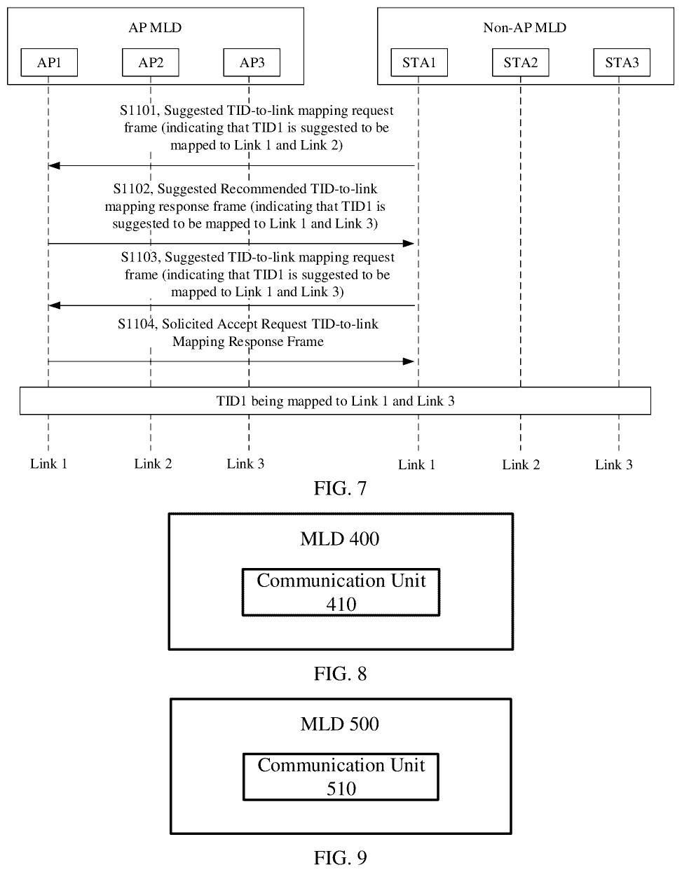

As shown in FIG. 7, it may include the following steps: S1101, in which the Non-AP MLD transmits a Suggested TID-to-link mapping request, and the Suggested TID-to-link mapping request frame includes a Suggested TID-to-link mapping parameter indicating that TID1 is suggested to be mapped to Link1 and Link2.

S1102, in which the AP MLD receives the Suggested TID-to-link mapping request frame. Further, the AP MLD transmits an Alternative Recommended TID-to-link mapping response frame, which carries a Suggested TID-to-link mapping parameter indicating that TID1 is suggested to be mapped to Link1 and Link3.

Alternatively, the AP MLD may transmit the Alternative Recommended TID-to-link mapping response frame carrying the Suggested TID-to-link mapping parameter, in the case where the Suggested TID-to-link mapping parameter carried in the Suggested TID-to-link mapping request frame cannot satisfy the current TID-to-link mapping cell of the AP MLD.

S1103, in which after receiving the Alternative Recommended TID-to-link mapping response, the Non-AP MLD transmits, to the AP MLD, a Suggested TID-to-link mapping frame that includes a TID-to-link mapping parameter indicating that TID1 may be mapped to Link1 and Link3.

S1104, in which the AP MLD transmits a Solicited Accept TID-to-link mapping response, accepting the Suggested TID-to-link mapping request frame, so as to set up a TID-to-link mapping, that is, TID1 is mapped to Link 1 and Link 3.

By setting a plurality of response types of TID-to-link mapping response frames and/or a plurality of request types of TID-to-Link mapping request frames, a TID-to-Link mapping requester may perform a TID-to-Link mapping request with an appropriate type of TID-to-Link mapping request frame according to particular scenarios; and accordingly, a TID-to-Link mapping responder may perform a TID-to-Link mapping response with an appropriate type of TID-to-Link mapping response frame according to particular scenarios. This facilitates to satisfy requirements of different scenarios, and improve the negotiation efficiency of TID-to-Link mapping setup.

FIG. 8 shows a schematic block diagram of a MLD 400 according to an embodiment of the present disclosure. As shown in FIG. 8, the MLD 400 includes:

a communication unit 410 configured to transmit a first TID-to-link mapping response frame to a second MLD, the first TID-to-link mapping response frame including TID-to-link mapping response information, and the TID-to-link mapping response information including a TID-to-link mapping parameter and/or type indication information indicating a response type of the first TID-to-link mapping response frame.

In some embodiments of the present disclosure, the first TID-to-link mapping response frame includes a TID-to-link mapping element for carrying the TID-to-link mapping response information.

In some embodiments of the present disclosure, the TID-to-link mapping element includes: a TID-to-link mapping parameter field for carrying the TID-to-link mapping parameter, and a control field including a type field for carrying the type indication information.

In some embodiments of the present disclosure, the type indication information indicates that the response type of the first TID-to-link mapping response frame is a Type 1 response type, the Type 1 response type being a TID-to-link mapping response frame based on a TID-to-link mapping request frame.

In some embodiments of the present disclosure, the Type 1 response type includes at least one of:
a first response type, the first response type of TID-to-link mapping response frame indicating that the first MLD accepts a TID-to-link mapping requested by the TID-to-link mapping request frame;
a second response type, the second response type of TID-to-link mapping response frame indicating that the first MLD denies setting up the TID-to-link mapping requested by the TID-to-link mapping request frame;
a third response type, the third response type of TID-to-link mapping response frame indicating that the first MLD does not set up the TID-to-link mapping requested by the TID-to-link mapping request frame, and the third response type of TID-to-link mapping response frame including a TID-to-link mapping parameter required by the first MLD; or
a fourth response type, the fourth response type of TID-to-link mapping response frame indicating that the first MLD does not set up the TID-to-link mapping requested by the TID-to-link mapping request frame, and the fourth response type of TID-to-link mapping response frame including a TID-to-link mapping parameter suggested by the first MLD.

In some embodiments of the present disclosure, the communication unit 410 is further configured to receive a first TID-to-link mapping request frame transmitted by the second MLD.

In some embodiments of the present disclosure, the MLD 400 further include a processing unit configured to determine a response type corresponding to the first TID-to-link mapping response frame based on a request type corresponding to the first TID-to-link mapping request frame and/or a TID-to-link mapping requirement of the MLD.

In some embodiments of the present disclosure, the request type corresponding to the first TID-to-link mapping request frame is one of:
a first request type, the first request type of TID-to-link mapping request frame including no TID-to-link mapping parameter;
a second request type, the second request type of TID-to-link mapping request frame including a TID-to-link mapping parameter required by the second MLD; or
a third request type, the third request type of TID-to-link mapping request frame including a TID-to-link mapping parameter suggested by the second MLD.

In some embodiments of the present disclosure, the processing unit is further configured to: if the request type corresponding to the first TID-to-link mapping request frame is the first request type, determine that the response type corresponding to the first TID-to-link mapping response frame is the first response type or the second response type, the first response type of TID-to-link mapping response frame including the TID-to-link mapping parameter; or

if the request type corresponding to the first TID-to-link mapping request frame is the second request type, determine that the response type corresponding to the first TID-to-link mapping response frame is the first response type, the second response type, the third response type, or the fourth response type; or

if the request type corresponding to the first TID-to-link mapping request frame is the third request type, determine that the response type corresponding to the first TID-to-link mapping response frame is the first response type, the second response type, the third response type, or the fourth response type.

In some embodiments of the present disclosure, the communication unit 410 is further configured to: if the response type of the first TID-to-link mapping response frame is the third response type, receive a second TID-to-link mapping request frame transmitted by the second MLD, the second TID-to-link mapping request frame including the TID-to-link mapping parameter required by the MLD.

In some embodiments of the present disclosure, the communication unit 410 is further configured to transmit a second TID-to-link mapping response frame to the second MLD, the second TID-to-link mapping response frame indicating that the MLD accepts the TID-to-link mapping request of the second TID-to-link mapping request frame.

In some embodiments of the present disclosure, the communication unit 410 is further configured to: if the response type of the first TID-to-link mapping response frame is the fourth response type, receive a third TID-to-link mapping request frame transmitted by the second MLD, the third TID-to-link mapping request frame including the TID-to-link mapping parameter suggested by the first MLD.

In some embodiments of the present disclosure, the communication unit 410 is further configured to transmit a third TID-to-link mapping response frame to the second MLD, the third TID-to-link mapping response frame indicating that the MLD accepts the TID-to-link mapping request of the third TID-to-link mapping request frame.

In some embodiments of the present disclosure, the first TID-to-link mapping request frame includes TID-to-link mapping request information, the TID-to-link mapping request information including the TID-to-link mapping parameter and/or type indication information indicating the request type of the first TID-to-link mapping request frame.

In some embodiments of the present disclosure, the first TID-to-link mapping request frame includes a TID-to-link mapping element for carrying the TID-to-link mapping request information.

In some embodiments of the present disclosure, the TID-to-link mapping element includes: a TID-to-link mapping parameter field for carrying the TID-to-link mapping parameter, and a control field including a type field for carrying the type indication information.

In some embodiments of the present disclosure, the first TID-to-link mapping request frame is one of:

a beacon frame, an association request frame, or a reassociation request frame.

In some embodiments of the present disclosure, the first TID-to-link mapping request frame is an action frame, and the type indication information is carried in an Extremely High Throughput (EHT) action field or status code field of the action frame; or

the type indication information includes frame type indication information carried in the EHT action field of the action frame and request type indication information carried in a subtype field of the action frame; or

the type indication information includes frame type indication information carried in the EHT action field of the action frame and request type indication information carried in the status code field of the action frame.

The frame type indication information indicates that the first TID-to-link mapping request frame is a TID-to-link mapping request frame, and the request type indication information indicates the request type of the first TID-to-link mapping request frame.

In some embodiments of the present disclosure, the type indication information indicates that the response type of the first TID-to-link mapping response frame is a Type 2 response type, and the Type 2 response type is a TID-to-link mapping response frame not based on the TID-to-link mapping request frame.

In some embodiments of the present disclosure, the Type 2 response type includes at least one of:
a fifth response type, the fifth response type of TID-to-link mapping response frame including a TID-to-link mapping parameter, and the receiving MLD of the fifth response type of TID-to-link mapping response frame setting up the TID-to-link mapping according to the TID-to-link mapping parameter;
a sixth response type, the sixth response type of TID-to-link mapping response frame including a TID-to-link mapping parameter required by the MLD, and the receiving MLD of the sixth response type of TID-to-link mapping response frame transmitting, to the MLD, a TID-to-link mapping request frame for setting up the TID-to-link mapping according to the TID-to-link mapping parameter required by the MLD; or
a seventh response type, the seventh response type of TID-to-link mapping response frame including a TID-to-link mapping parameter suggested by the MLD, and the receiving MLD of the seventh response type of TID-to-link mapping response frame transmitting, to the MLD, a TID-to-link mapping request for setting up the TID-to-link mapping according to the TID-to-link mapping parameter suggested by the MLD.

In some embodiments of the present disclosure, the communication unit 410 is further configured to receive a fourth TID-to-link mapping request frame transmitted by the second MLD, the fourth TID-to-link mapping request frame including the TID-to-link mapping parameter required by the MLD.

In some embodiments of the present disclosure, the communication unit 410 is further configured to transmit a fourth TID-to-link mapping response frame to the second MLD, the fourth TID-to-link mapping response frame indicating that the MLD accepts a TID-to-link mapping that the fourth TID-to-link mapping request frame requests to set up.

In some embodiments of the present disclosure, the communication unit 410 is further configured to receive a fifth TID-to-link mapping request frame transmitted by the second MLD, the fifth TID-to-link mapping request frame including the TID-to-link mapping parameter suggested by the MLD.

In some embodiments of the present disclosure, the communication unit 410 is further configured to transmit a fifth TID-to-link mapping response frame to the second MLD, the fifth TID-to-link mapping response frame indicating that the MLD accepts a TID-to-link mapping that the fifth TID-to-link mapping request frame requests to set up.

In some embodiments of the present disclosure, the first TID-to-link mapping response frame is one of:

a beacon frame, a probe response frame, an association response frame, or a reassociation response frame.

In some embodiments of the present disclosure, the first TID-to-link mapping response frame is an action frame, and the type indication information is carried in an Extremely High Throughput (EHT) action field or status code field of the action frame; or

the type indication information includes frame type indication information carried in the EHT action field of the action frame and response type indication information carried in a subtype field of the action frame; or

the type indication information includes frame type indication information carried in the EHT action field of the action frame and response type indication information carried in the status code field of the action frame.

The frame type indication information indicates that the first TID-to-link mapping response frame is a TID-to-link mapping response frame, and the response type indication information indicates the response type of the first TID-to-link mapping response frame.

Alternatively, in some embodiments, the above-mentioned communication unit may be a communication interface or a transceiver, or an input/output interface of a communication chip or a system-on-chip. The above-mentioned processing unit may be one or more processors.

It should be understood that the MLD 400 according to the embodiments of the present disclosure may correspond to the terminal device in the method embodiments of the present disclosure, and the above-mentioned and other operations and/or functions of each unit in the MLD 400 are used for implementing the corresponding processes of the first MLD in the method embodiments as shown in FIG. 3 to FIG. 7, and description thereof will not be repeated here for the sake of brevity.

FIG. 9 shows a schematic block diagram of a MLD according to an embodiment of the present disclosure. As shown in FIG. 9, the MLD 500 includes:

a communication unit 510 configured to receive a first TID-to-link mapping response frame transmitted by a first MLD, the first TID-to-link mapping response frame including TID-to-link mapping response information, and the TID-to-link mapping response information including a TID-to-link mapping parameter and/or type indication information indicating a response type of the first TID-to-link mapping response frame.

In some embodiments of the present disclosure, the first TID-to-link mapping response frame includes a TID-to-link mapping element for carrying the TID-to-link mapping response information.

In some embodiments of the present disclosure, the TID-to-link mapping element includes: a TID-to-link mapping parameter field for carrying the TID-to-link mapping parameter, and a control field including a type field for carrying the type indication information.

In some embodiments of the present disclosure, the type indication information indicates that the response type of the first TID-to-link mapping response frame is a Type 1 response type, and the Type 1 response type is a TID-to-link mapping response frame based on a TID-to-link mapping request frame.

In some embodiments of the present disclosure, the Type 1 response type includes at least one of:
a first response type, the first response type of TID-to-link mapping response frame indicating that the first MLD accepts a TID-to-link mapping requested by the TID-to-link mapping request frame;
a second response type, the second response type of TID-to-link mapping response frame indicating that the first MLD denies setting up the TID-to-link mapping requested by the TID-to-link mapping request frame;
a third response type, the third response type of TID-to-link mapping response frame indicating that the first MLD does not set up the TID-to-link mapping requested by the TID-to-link mapping request frame, and the third response type of TID-to-link mapping response frame including a TID-to-link mapping parameter required by the first MLD; or
a fourth response type, the fourth response type of TID-to-link mapping response frame indicating that the first MLD does not set up the TID-to-link mapping requested by the TID-to-link mapping request frame, and the fourth response type of TID-to-link mapping response frame including a TID-to-link mapping parameter suggested by the first MLD.

In some embodiments of the present disclosure, the communication unit 510 is further configured to transmit a first TID-to-link mapping request frame to the first MLD, a response type corresponding to the first TID-to-link mapping response frame being determined by the first MLD according to a request type corresponding to the first TID-to-link mapping request frame and/or a TID-to-link mapping requirement of the first MLD.

In some embodiments of the present disclosure, the request type corresponding to the first TID-to-link mapping request frame is one of:
a first request type, the first request type of TID-to-link mapping request frame including no TID-to-link mapping parameter;
a second request type, the second request type of TID-to-link mapping request frame including a TID-to-link mapping parameter required by the MLD; or
a third request type, the third request type of TID-to-link mapping request frame including a TID-to-link mapping parameter suggested by the MLD.

In some embodiments of the present disclosure, the request type corresponding to the first TID-to-link mapping request frame is the first request type, and the response type corresponding to the first TID-to-link mapping response frame is the first response type or the second response type, the first response type of TID-to-link mapping response frame including the TID-to-link mapping parameter; or
the request type corresponding to the first TID-to-link mapping request frame is the second request type, and the response type corresponding to the first TID-to-link mapping response frame is the first response type, the second response type, the third response type, or the fourth response type; or
the request type corresponding to the first TID-to-link mapping request frame is the third request type, and the response type corresponding to the first TID-to-link mapping response frame is the first response type, the second response type, the third response type, or the fourth response type.

In some embodiments of the present disclosure, the communication unit 510 is further configured to: if the response type corresponding to the first TID-to-link mapping response frame is the third response type, transmit a second TID-to-link mapping request frame to the first MLD, the second TID-to-link mapping request frame including the TID-to-link mapping parameter required by the first MLD.

In some embodiments of the present disclosure, the communication unit 510 is further configured to receive a second TID-to-link mapping response frame transmitted by the first MLD, the second TID-to-link mapping response frame indicating that the first MLD accepts the TID-to-link mapping request of the second TID-to-link mapping request frame.

In some embodiments of the present disclosure, the communication unit 510 is further configured to: if the response type corresponding to the first TID-to-link mapping response frame is the fourth response type, transmit a third TID-to-link mapping request frame to the first MLD, the third TID-to-link mapping request frame including the TID-to-link mapping parameter suggested by the first MLD.

In some embodiments of the present disclosure, the communication unit 510 is further configured to receive a third TID-to-link mapping response frame transmitted by the first MLD, the third TID-to-link mapping response frame indicating that the first MLD accepts the TID-to-link mapping request of the third TID-to-link mapping request frame.

In some embodiments of the present disclosure, the first TID-to-link mapping request frame includes TID-to-link mapping request information, the TID-to-link mapping request information including the TID-to-link mapping parameter and/or type indication information indicating the request type of the first TID-to-link mapping request frame.

In some embodiments of the present disclosure, the first TID-to-link mapping request frame includes a TID-to-link mapping element for carrying the TID-to-link mapping request information.

In some embodiments of the present disclosure, the TID-to-link mapping element includes: a TID-to-link mapping parameter field for carrying the TID-to-link mapping parameter, and a control field including a type field for carrying the type indication information.

In some embodiments of the present disclosure, the first TID-to-link mapping request frame is one of:

a beacon frame, an association request frame, or a reassociation request frame.

In some embodiments of the present disclosure, the first TID-to-link mapping request frame is an action frame, and the type indication information is carried in an Extremely High Throughput (EHT) action field or status code field of the action frame; or

the type indication information includes frame type indication information carried in the EHT action field of the action frame and request type indication information carried in a subtype field of the action frame; or

the type indication information includes frame type indication information carried in the EHT action field of the action frame and request type indication information carried in the status code field of the action frame.

The frame type indication information indicates that the first TID-to-link mapping request frame is a TID-to-link mapping request frame, and the request type indication information indicates the request type of the first TID-to-link mapping request frame.

In some embodiments of the present disclosure, the type indication information indicates that the response type of the first TID-to-link mapping response frame is a Type 2 response type, and the Type 2 response type is a TID-to-link mapping response frame not based on the TID-to-link mapping request frame.

In some embodiments of the present disclosure, the Type 2 response type includes at least one of:
a fifth response type, the fifth response type of TID-to-link mapping response frame including a TID-to-link mapping parameter, and the receiving MLD of the fifth response type of TID-to-link mapping response frame setting up the TID-to-link mapping according to the TID-to-link mapping parameter;
a sixth response type, the sixth response type of TID-to-link mapping response frame including a TID-to-link mapping parameter required by the first MLD, and the receiving MLD of the sixth response type of TID-to-link mapping response frame transmitting, to the first MLD, a TID-to-link mapping request for setting up the TID-to-link mapping according to the TID-to-link mapping parameter required by the first MLD; or
a seventh response type, the seventh response type of TID-to-link mapping response frame including a TID-to-link mapping parameter suggested by the first MLD, and the receiving MLD of the seventh response type of TID-to-link mapping response frame transmitting, to the first MLD, a TID-to-link mapping request for setting up the TID-to-link mapping according to the TID-to-link mapping parameter suggested by the first MLD.

In some embodiments of the present disclosure, the communication unit 510 is further configured to transmit a fourth TID-to-link mapping request frame to the first MLD, the fourth TID-to-link mapping request frame including the TID-to-link mapping parameter required by the first MLD.

In some embodiments of the present disclosure, the communication unit 510 is further configured to receive a fourth TID-to-link mapping response frame transmitted by the first MLD, the fourth TID-to-link mapping response frame indicating that the first MLD accepts a TID-to-link mapping that the fourth TID-to-link mapping request frame requests to set up.

In some embodiments of the present disclosure, the communication unit 510 is further configured to transmit a fifth TID-to-link mapping request frame to the first MLD, the fifth TID-to-link mapping request frame including the TID-to-link mapping parameter suggested by the first MLD.

In some embodiments of the present disclosure, the communication unit 510 is further configured to receive a fifth TID-to-link mapping response frame transmitted by the first MLD, the fifth TID-to-link mapping response frame indicating that the first MLD accepts a TID-to-link mapping that the fifth TID-to-link mapping request frame requests to set up.

In some embodiments of the present disclosure, the first TID-to-link mapping response frame is one of:

a beacon frame, a probe response frame, an association response frame, or a reassociation response frame.

In some embodiments of the present disclosure, the first TID-to-link mapping response frame is an action frame, the type indication information is carried in an Extremely High Throughput (EHT) action field or status code field of the action frame; or

the type indication information includes frame type indication information carried in the EHT action field of the action frame and response type indication information carried in a subtype field of the action frame; or

the type indication information includes frame type indication information carried in the EHT action field of the action frame and response type indication information carried in the status code field of the action frame.

The frame type indication information indicates that the first TID-to-link mapping response frame is a TID-to-link mapping response frame, and the response type indication information indicates the response type of the first TID-to-link mapping response frame.

Alternatively, in some embodiments, the above-mentioned communication unit may be a communication interface or a transceiver, or an input/output interface of a communication chip or a system-on-chip. The above-mentioned processing unit may be one or more processors.

It should be understood that the MLD 500 according to the embodiments of the present disclosure may correspond to the second MLD in the method embodiments of the present disclosure, and the above-mentioned and other operations and/or functions of each unit in the MLD 500 are used for implementing the corresponding processes of the second MLD in the method embodiments as shown in FIGS. 3 to 7, description thereof will not be repeated here for the sake of brevity.

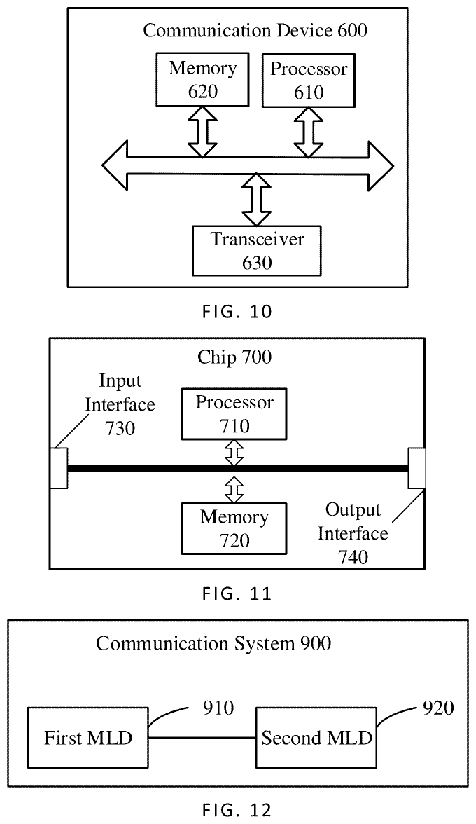

FIG. 10 is a schematic structural diagram of a communication device 600 according to an embodiment of the present disclosure. The communication device 600 as shown in FIG. 10 may include a processor 610. The processor 610 may be configured to invoke and execute a computer program from the memory, to implement the methods in the embodiments of the present disclosure.

Alternatively, as shown in FIG. 10, the communication device 600 may further include a memory 620. The processor 610 may be configured to invoke and execute a computer program from the memory 620, to implement the methods in the embodiments of the present disclosure.

The memory 620 may be an independent device separately from the processor 610, or may be integrated in the processor 610.

Alternatively, as shown in FIG. 10, the communication device 600 may further include a transceiver 630. The processor 610 may be configured to control the transceiver 630 to communicate with other devices, and in particular, transmit information or data to other devices, or receive information or data sent by other devices.

The transceiver 630 may include a transmitter and a receiver. The transceiver 630 may further include antennas, and the number of antennas may be one or more.

Alternatively, the communication device 600 may be the first MLD in the embodiments of the present disclosure, and the communication device 600 may implement the corresponding processes implemented by the first MLD in each method of the embodiment of the present disclosure, and details thereof will not be repeated here for the sake of brevity.

Alternatively, the communication device 600 in the embodiment of the present disclosure may be the second MLD, and the communication device 600 may implement the corresponding processes implemented by the second MLD in each method of the embodiment of the present disclosure, and details thereof will not be repeated here for the sake of brevity.

FIG. 11 is a schematic structural diagram of a chip according to an embodiment of the present disclosure. The chip 700 as shown in FIG. 11 includes a processor 710. The processor 710 may be configured to invoke and execute a computer program from the memory, to implement the methods in the embodiments of the present disclosure.

Alternatively, as shown in FIG. 11, the chip 700 may further include a memory 720. The processor 710 may be configured to invoke and execute a computer program from the memory 720, to implement the method in the embodiment of the present disclosure.

The memory 720 may be an independent device separately from the processor 710, or may be integrated in the processor 710.

Alternatively, the chip 700 may further include an input interface 730. The processor 710 may be configured to control the input interface 730 to communicate with other devices or chips, and in particular, obtain information or data transmitted by other devices or chips.

Alternatively, the chip 700 may further include an output interface 740. The processor 710 may be configured to control the output interface 740 to communicate with other devices or chips, and in particular, output information or data to other devices or chips.

Alternatively, the chip may be applied to the first MLD in the embodiments of the present disclosure, and the chip may implement the corresponding processes implemented by the first MLD in the various methods of the embodiments of the present disclosure, and details thereof will not be repeated here for the sake of brevity.

Alternatively, the chip may be applied to the second MLD in the embodiments of the present disclosure, and the chip may implement the corresponding processes implemented by the second MLD in the various methods of the embodiments of the present disclosure, and details thereof will not be repeated here for the sake of brevity.

It should also be understood that the chip in the embodiments of the present disclosure may also be called a system level chip, a system chip, a chip system, or a system-on-chip, etc.

FIG. 12 is a schematic block diagram of a communication system 900 provided by an embodiment of the present disclosure. As shown in FIG. 12, the communication system 900 includes a first MLD 910 and a second MLD 920.

The first MLD 910 may be configured to implement the corresponding functions implemented by the first MLD in the above methods, and the second MLD 920 may be configured to implement the corresponding functions implemented by the second MLD in the above methods.

It should be understood that the processor in the embodiments of the present disclosure may be an integrated circuit chip, which has signal processing capability. In the implementation process, each step of the above-mentioned method embodiments may be performed by an integrated logic circuit of hardware or instructions in software in a processor. The above-mentioned processor may be a general-purpose processor, a Digital Signal Processor (DSP), an Application Specific Integrated Circuit (ASIC), a Field Programmable Gate Array (FPGA), or other programmatic logic device, discrete gate or transistor logic device, discrete hardware component. Various methods, steps, and logic block diagrams disclosed in the embodiments of the present disclosure may be implemented or executed. The general-purpose processor may be a microprocessor, or the processor may be any conventional processor, or the like. The steps of the methods disclosed in the embodiments of the present disclosure may be directly embodied as being performed and completed by a hardware decoding processor, or by a combination of hardware and software modules in the decoding processor. The software modules may be located in a known storage medium in the related art, such as random access memory, flash memory, read-only memory, programmable read-only memory, electrically erasable programmable memory, or register. The storage medium may be located in the memory, and the processor may read information from the memory and perform the steps of the above methods in combination with its hardware.

It may be understood that the memory in the embodiments of the present disclosure may be a volatile memory or a non-volatile memory or both. The non-volatile memory may be a Read-Only Memory (ROM), a Programmable ROM (PROM), an Erasable PROM (EPROM), an Electrically EPROM (EEPROM), or a Flash. The volatile memory may be a Random Access Memory (RAM), which acts as an external cache. By way of illustration without any limitation, many forms of RAM are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a synch link DRAM (SLDRAM), and a Direct Rambus RAM (DR RAM). It should be understood that the above-mentioned memory is intended to include, but not be limited to, these and any other suitable types of memory.

It may be understood that the above mentioned memory is illustrative without any limitation. For example, the memory in the embodiments of the present disclosure may be a Static RAM (SRAM), a Dynamic RAM (DRAM), a Synchronous DRAM (SDRAM), a Double Data Rate SDRAM (DDR SDRAM), an Enhanced SDRAM (ESDRAM), a synch link DRAM (SLDRAM), and a Direct Rambus RAM (DR RAM). That is, the memory in the embodiments of the present disclosure is intended to include, but not be limited to, these and any other suitable types of memory.

An embodiment of the present disclosure also provides a computer-readable storage medium for storing a computer program.

Alternatively, the computer-readable storage medium may be applied to the first MLD in the embodiments of the present disclosure, and the computer program causes the computer to perform the corresponding processes implemented by the first MLD in the methods of the embodiments of the present disclosure, and details thereof will not be repeated here for the sake of brevity.

Alternatively, the computer-readable storage medium may be applied to the second MLD in the embodiments of the present disclosure, and the computer program causes the computer to perform the corresponding processes implemented by the second MLD in the methods of the embodiments of the present disclosure, and details thereof will not be repeated here for the sake of brevity.

An embodiment of the present disclosure also provides a computer program product including computer program instructions.

Alternatively, the computer program product may be applied to the first MLD in the embodiment of the present disclosure, and the computer program instructions cause the computer to perform the corresponding processes implemented by the first MLD in each method of the embodiments of the present disclosure, and details thereof will not be repeated here for the sake of brevity.

Alternatively, the computer program product may be applied to the second MLD in the embodiment of the present disclosure, and the computer program instructions cause the computer to perform the corresponding processes implemented by the second MLD in each method of the embodiments of the present disclosure, and details thereof will not be repeated here for the sake of brevity.

An embodiment of the present disclosure also provides a computer program.

Alternatively, the computer program may be applied to the first MLD in the embodiment of the present disclosure. The computer program, when running on the computer, causes the computer to perform the corresponding processes implemented by the first MLD in each method of the embodiments of the present disclosure, and details thereof will not be repeated here for the sake of brevity.

Alternatively, the computer program may be applied to the second MLD in the embodiment of the present disclosure. The computer program, when running on the computer, causes the computer to perform the corresponding processes implemented by the second MLD in each method of the embodiments of the present disclosure, and details thereof will not be repeated here for the sake of brevity.

The skilled in the art may appreciate that the units and algorithm steps of the examples described in conjunction with the embodiments disclosed herein may be implemented by electronic hardware, or a combination of computer software and electronic hardware. Whether these functions are executed by hardware or software depends on the specific application and design constraints of the technical solution. Professionals and technicians may use different methods to implement the described functions for each specific application, but such implementation should not be regarded as going beyond the scope of the embodiments of the present disclosure.

The skilled in the art may also realize that, for convenience and brevity of description, the specific operating process of the above-described system, apparatus, and unit may refer to the corresponding process in the foregoing method embodiments, and details thereof will not be repeated here.

In the several embodiments provided in the present disclosure, it should be understood that the disclosed systems, apparatuses and methods may be implemented in other ways. For example, the above mentioned apparatus embodiments are only illustrative. For example, the division of units or modules or components in the above-described apparatus embodiments is only a logical function division, and there may be other division approaches in actual implementations. For example, multiple units or modules or components may be combined or integrated to another system, or some units or modules or components may be ignored, or not implemented. For another example, mutual coupling or direct coupling or communication connection shown or discussed above may be indirect coupling or communication connection of apparatuses or units via some interfaces, and may be in electrical, mechanical or other forms.

The units described as separate components may or may not be physically separated, and the components shown as units may or may not be physical units, that is, they may be co-located, or may be distributed to multiple network units. Part or all of the units may be selected according to actual needs to achieve the purpose of the technical solutions of the embodiments.

In addition, each functional unit in each embodiment of the present disclosure may be integrated into one processing unit, or may physically exist separately. Or, two or more units may be integrated into one unit.

When the function is implemented in the form of a software functional unit and sold or used as a standalone product, it may be stored in a computer-readable storage medium. Based on this understanding, all or part of the technical solutions according to the present disclosure, or the part thereof that contributes to the prior art, may be embodied in the form of a software product. The computer software product may be stored in a storage medium and contain instructions to enable a computer device, such as a personal computer, a server, or a network device, etc., to perform all or part of the steps of the method described in each of the embodiments of the present disclosure. The above mentioned storage medium may include various mediums capable of storing program codes, such as a Universal Serial Bus flash drive, a mobile hard disk, an ROM, an RAM, a magnetic disk, or an optical disc.

While the specific embodiments of the present disclosure have been described above, the protect scope of the present disclosure is not limited to these embodiments. Various variants and alternatives may be easily conceived by any of those skilled in the art without departing from the technical scope of the present disclosure. Therefore, these variants and alternatives are to be encompassed by the protect scope of present disclosure as defined by the claims as attached.

What is claimed is:

1. A Traffic Identifier ‘TID’-to-link mapping method, comprising:
transmitting, by a first Multi-Link Device ‘MLD’, a first TID-to-link mapping response frame to a second MLD,
wherein the first TID-to-link mapping response frame comprises TID-to-link mapping response information, the TID-to-link mapping response information comprising: type indication information indicating a response type of the first TID-to-link mapping response frame; and/or a TID-to-link mapping parameter.

2. The method according to claim 1, wherein the first TID-to-link mapping response frame comprises a TID-to-link mapping element for carrying the TID-to-link mapping response information.

3. The method according to claim 2, wherein the TID-to-link mapping element comprises:
a control field, the control field comprising a type field for carrying the type indication information; and
a TID-to-link mapping parameter field for carrying the TID-to-link mapping parameter.

4. The method according to claim 1, wherein the type indication information indicates that the response type of the first TID-to-link mapping response frame is a Type 2 response type, wherein the Type 2 response type is a TID-to-link mapping response frame not based on a TID-to-link mapping request frame.

5. The method according to claim 4, wherein the Type 2 response type comprises at least one of:
a fifth response type, wherein the fifth response type of TID-to-link mapping response frame comprises a TID-to-link mapping parameter, and the receiving MLD of the fifth response type of TID-to-link mapping response frame sets up the TID-to-link mapping according to the TID-to-link mapping parameter;
a sixth response type, wherein the sixth response type of TID-to-link mapping response frame comprises a TID-to-link mapping parameter required by the first MLD, and the receiving MLD of the sixth response type of TID-to-link mapping response frame transmits, to the first MLD, a TID-to-link mapping request for setting up the TID-to-link mapping according to the TID-to-link mapping parameter required by the first MLD; or
a seventh response type, wherein the seventh response type of TID-to-link mapping response frame comprises a TID-to-link mapping parameter suggested by the first MLD, and the receiving MLD of the seventh response type of TID-to-link mapping response frame transmits, to the first MLD, a TID-to-link mapping request for setting up the TID-to-link mapping according to the TID-to-link mapping parameter suggested by the first MLD.

6. The method according to claim 1, wherein the first TID-to-link mapping response frame is one of:
a beacon frame,
a probe response frame,
an association response frame, or
a reassociation response frame.

7. A Multi-Link Device ‘MLD’, comprising:
a processor, and
a memory having a computer program stored thereon, wherein the processor is configured to invoke and execute the computer program stored on the memory, to:
transmit a first TID-to-link mapping response frame to a second MLD,
wherein the first TID-to-link mapping response frame comprises TID-to-link mapping response information, the TID-to-link mapping response information comprising: type indication information indicating a response type of the first TID-to-link mapping response frame; and/or a TID-to-link mapping parameter.

8. The MLD according to claim 7, wherein the first TID-to-link mapping response frame comprises a TID-to-link mapping element for carrying the TID-to-link mapping response information.

9. The MLD according to claim 8, wherein the TID-to-link mapping element comprises:
a control field, the control field comprising a type field for carrying the type indication information; and
a TID-to-link mapping parameter field for carrying the TID-to-link mapping parameter.

10. The MLD according to claim 7, wherein the type indication information indicates that the response type of the first TID-to-link mapping response frame is a Type 2 response type, wherein the Type 2 response type is a TID-to-link mapping response frame not based on a TID-to-link mapping request frame.

11. The MLD according to claim 10, wherein the Type 2 response type comprises at least one of:
a fifth response type, wherein the fifth response type of TID-to-link mapping response frame comprises a TID-to-link mapping parameter, and the receiving MLD of the fifth response type of TID-to-link mapping response frame sets up the TID-to-link mapping according to the TID-to-link mapping parameter;
a sixth response type, wherein the sixth response type of TID-to-link mapping response frame comprises a TID-to-link mapping parameter required by the MLD, and the receiving MLD of the sixth response type of TID-to-link mapping response frame transmits, to the MLD, a TID-to-link mapping request for setting up the TID-to-link mapping according to the TID-to-link mapping parameter required by the MLD; or
a seventh response type, wherein the seventh response type of TID-to-link mapping response frame comprises a TID-to-link mapping parameter suggested by the MLD, and the receiving MLD of the seventh response type of TID-to-link mapping response frame transmits, to the MLD, a TID-to-link mapping request for setting up the TID-to-link mapping according to the TID-to-link mapping parameter suggested by the MLD.

12. The MLD according to claim 7, wherein the first TID-to-link mapping response frame is one of:
a beacon frame,
a probe response frame,
an association response frame, or
a reassociation response frame.

13. A Multi-Link Device ‘MLD’, comprising:
a processor, and
a memory having a computer program stored thereon, wherein the processor is configured to invoke and execute the computer program stored on the memory, to:
receive a first TID-to-link mapping response frame transmitted by a first MLD,
wherein the first TID-to-link mapping response frame comprises TID-to-link mapping response information, the TID-to-link mapping response information comprising: type indication information indicating a response type of the first TID-to-link mapping response frame; and/or a TID-to-link mapping parameter.

14. The MLD according to claim 13, wherein the first TID-to-link mapping response frame comprises a TID-to-link mapping element for carrying the TID-to-link mapping response information.

15. The MLD according to claim 14, wherein the TID-to-link mapping element comprises:
a control field, the control field comprising a type field for carrying the type indication information; and
a TID-to-link mapping parameter field for carrying the TID-to-link mapping parameter.

16. The MLD according to claim 13, wherein the type indication information indicates that the response type of the first TID-to-link mapping response frame is a Type 2 response type, wherein the Type 2 response type is a TID-to-link mapping response frame not based on a TID-to-link mapping request frame.

17. The MLD according to claim 16, wherein the Type 2 response type comprises at least one of:
a fifth response type, wherein the fifth response type of TID-to-link mapping response frame comprises a TID-to-link mapping parameter, and the receiving MLD of the fifth response type of TID-to-link mapping response frame sets up the TID-to-link mapping according to the TID-to-link mapping parameter
a sixth response type, wherein the sixth response type of TID-to-link mapping response frame comprises a TID-to-link mapping parameter required by the first MLD, and the receiving MLD of the sixth response type of TID-to-link mapping response frame transmits, to the first MLD, a TID-to-link mapping request for setting up the TID-to-link mapping according to the TID-to-link mapping parameter required by the first MLD;
a seventh response type, wherein the seventh response type of TID-to-link mapping response frame comprises a TID-to-link mapping parameter suggested by the first MLD, and the receiving MLD of the seventh response type of TID-to-link mapping response frame transmits, to the first MLD, a TID-to-link mapping request for setting up the TID-to-link mapping according to the TID-to-link mapping parameter suggested by the first MLD.

18. The MLD according to claim 13, wherein the first TID-to-link mapping response frame is one of:
a beacon frame,
a probe response frame,
an association response frame, or
a reassociation response frame.

19. A computer-readable storage medium, having a computer program stored thereon, wherein the computer program causes a computer to perform the method according to claim 1.

20. The computer-readable storage medium according to claim 19, wherein the first TID-to-link mapping response frame comprises a TID-to-link mapping element for carrying the TID-to-link mapping response information.
